(19) United States
(12) Patent Application Publication
(10) Pub. No.: US 2014/0263523 A1
(43) Pub. Date: Sep. 18, 2014

(54) DEVICES AND METHODS FOR BREAKING AND STORING A SAFETY RAZOR BLADE

(71) Applicant: DAVID L. ALLYN, CLERMONT, FL (US)

(72) Inventor: DAVID L. ALLYN, CLERMONT, FL (US)

(21) Appl. No.: 13/804,249

(22) Filed: Mar. 14, 2013

(51) Int. Cl. B23D 31/00; B26F 3/04

(52) U.S. Cl. CPC B23D 31/002; B26F 3/04
USPC 225/1; 225/103

(57) ABSTRACT

Devices and methods for breaking and storing whole or half razor blades. More specifically, devices and methods that can be used by hand to safely and easily break whole razor blades and store the broken blade halves for later use. Specific devices and methods remove whole or half blades and paper wrapper, provide convenient and safe storage and disposal of whole or half blades, and store and transport whole or half blades to minimize or eliminate hand contact and prevent injury, infection and bodily contamination.

### BACKGROUND OF INVENTION

Dermatology is a broad field of medicine that specializes in the diagnosis and treatment of various skin conditions. Oftentimes, such diagnosis and/or treatment requires curettage or even the removal of a small portion of skin, perhaps for biopsy purposes or to eliminate an undesirable growth, such as a mole or wart. The method utilized to remove a skin sample will depend in part on the skin size and depth to which the sample must be taken.

The shave skin biopsy method is most commonly utilized when a skin sample will be confined to the epidermal and dermal layers. It is relatively simple to perform and requires only a sharp razor blade. A double-edged stainless steel razor blade, the type often utilized with a safety razor device, having a longitudinal spindle slot can be used for these procedures. Typically, however, such razor blades are broken or “cracked” longitudinally along the length of the spindle slot to produce two equal half blades for individual use. Safety razor blades used for dermatological procedures are also individually wrapped. Once the blade is broken and removed from the wrapper, one half of the blade can then be held between the thumb and either the forefinger or middle finger and used to gently shave off the desired amount of skin. If necessary, the blade can be squeezed or pressed between the two fingers to impart a bend to the blade for taking a sample slightly below the epidermis into the dermis (or less commonly subcutis/fat). Razor blades are ideal for this procedure because their flexibility allows a dermatologist or other medical practitioner considerable control over the size and depth of the sample taken. They are also inexpensive, the wounds tend to heal quickly, and they cause little or no obvious scarring.

The process of breaking a razor blade in half is relatively simple, but has great potential to cause accidental injury. Typically the two sides of a razor blade are held with the sharp edges between the fingers on two hands and the blade is simply bent in half until it breaks in the middle at either end of the spindle slot. A pair of scissors or other device can also be used to cut a razor blade in half. Still another method requires folding or bending a razor blade with one edge against a hard surface. Unfortunately, all of these methods necessitate the hands and fingers being exposed to potential injury from the sharp razor edges, particularly at the moment when the razor blade breaks in half. If the razor blade is kept in the wrapper when being broken, the halves must be retrieved from the wrapper. After breaking the razor blade, however, the wrapper is often torn and jagged on one side and still sealed on the other side. So, the blade halves must be carefully worked out of the wrapper prior to use.

Since this procedure of breaking razor blades can be time-consuming, it is common to break several blades at one time and store them for later use. The broken blade halves are often disorderly stored in a common container, from which a single blade half must be carefully extracted. Needless to say, using the fingers to extract a single blade half from a container of exposed sharp edges can be risky.

The use of razor blades by dermatologists will likely continue to be a preferred technique. So, a device and method of use are needed that allow blades to be more safely broken without exposing the hands or fingers to the sharp edges. An ideal device would eliminate the need to directly contact a blade at all, until it had been broken and extracted from a wrapper. Since some procedures utilize a full blade, a device capable of just extracting a blade from the wrapper would also be helpful. It can also be beneficial to have a device and method for storing multiple blade halves for safety and sterility purposes.

### BRIEF SUMMARY

Dermatological procedures like curettage and tissue excisions are often performed with one half of a double-edged razor blade of the type used in safety razors. The blades are usually held between the thumb and second or third fingers and bent or curved to achieve the desired cutting depth. A whole razor blade can be used and may be preferred for some procedures. But, most procedures are more easily facilitated when the blade is broken or “cracked” in half, so that only half of a blade needs to be bent or manipulated by the fingers for a procedure.

There are a variety of techniques utilized to crack a blade in half, which usually entail holding at least some part of the blade with the hands or the fingers. Injuries caused by cracking blades for procedures are common and have resulted in serious injuries and disability. Razor blades used in dermatological procedures are individually wrapped, which can provide some limited protection when the blades are cracked. However, this requires the arduous procedure of extracting the cracked blade halves from the wrapper, which has usually been torn on one side and often is still sealed on the other side.

The subject invention successfully addresses the above described disadvantages associated with breaking or cracking razor blades and provides certain attributes and advantages, which improve the safety and ease of performing the procedure. In particular, the subject invention provides novel, inexpensive, and highly effective methods and devices for convenient and effective breaking of razor blades and for their manipulation prior to use in a dermatological procedure.

Embodiments of the subject invention include a pad on which a razor blade can be positioned and securely held. The pad can be flexible so that when folded over and compressed, a blade placed thereon can be cracked. The pad can include a cut or slit that allows the broken blade halves to drop through the compressed pad. There can also be one or more slide elements that can move the blade halves to one edge of the pad for grasping or deposit into a storage container.

Additional embodiments of the subject invention also include a razor blade extractor, which can include a surface with one or more prongs on which a wrapped razor blade can be placed and a blade conveyor that can make an operable connection with the razor blade. The wrapper of the razor blade can be engaged with the one or more prongs. The blade conveyor can slide under and into the wrapper and operably connect with the razor blade. As the blade conveyor is advanced, it forces the wrapper, held by the prongs, to separate and the operable connection with the razor blade allows the blade conveyor to extract the razor blade from the wrapper without contact with the hands. The blade conveyor can then be used to move the unwrapped blade safely.

The safe and convenient storage of both whole and half razor blades can be achieved with several embodiments of the subject invention. In one embodiment, a magnetized surface is used to anchor whole or half blades lying flat on the surface. Multiple blades can be disposed on each surface and several surfaces can be stacked and stored. In another embodiment, a storage container can be configured to receive multiple half blades that are stored in a stacked arrangement within the container, so they can be easily extracted for later use.

### BRIEF DESCRIPTION OF DRAWINGS

In order that a more precise understanding of the above recited invention can be obtained, a more particular description of the invention briefly described above will be rendered by reference to specific embodiments thereof that are illustrated in the appended drawings. The drawings presented herein may not be drawn to scale and any reference to dimensions in the drawings or the following description is specific to the embodiments disclosed. Any variations of these dimensions that will allow the subject invention to function for its intended purpose are considered to be within the scope of the subject invention. Thus, understanding that these drawings depict only typical embodiments of the invention and are not therefore to be considered as limiting in scope, the invention will be described and explained with additional specificity and detail through the use of the accompanying drawings in which:

FIG. 1 illustrates the features and structures on the inside surface of one embodiment of a breaking pad of the subject invention.

FIG. 2 illustrates examples of features and structures on the outside surface of one embodiment of a breaking pad of the subject invention.

FIG. 3A illustrates one embodiment of a breaking pad of the subject invention with a blade thereon in position for being cracked.

FIG. 3B illustrates another embodiment of a breaking pad of the subject invention having a retractable wrapper cutting mechanism.

FIG. 4 illustrates one embodiment of a breaking pad of the subject invention, where the side panels are raised.

FIG. 5 illustrates one embodiment of a breaking pad of the subject invention, wherein a blade has been cracked to create two half-blade portions. Also shown is a half-blade portion sliding out of a slit.

FIG. 6 illustrates one embodiment of a breaking pad of the subject invention, wherein the sliding mechanism has pushed a half-blade to a side edge.

FIG. 7 is a side elevation view of one embodiment of a breaking pad of the subject invention having an alternative embodiment of a sliding mechanism.

FIG. 8 is a front perspective view of a half-blade storage container according to the subject invention.

FIG. 9A is a front perspective view of an embodiment of a twin half-blade storage container, according to the subject invention.

FIG. 9B is a front perspective view of an alternative embodiment of a twin half-blade storage container, adapted to be a blade breaking storage container, according to the subject invention.

FIG. 10A illustrates an embodiment of a twin half-blade storage container with the containers angled apart, according to the subject invention.

FIG. 10B illustrates an alternative embodiment of a twin half-blade storage container, adapted to be a blade breaking storage container, here shown with the containers angled apart, according to the subject invention.

FIG. 11 illustrates an embodiment of a twin half-blade storage container, according to the subject invention, attached to one embodiment of a breaking pad. Also shown is a half-blade on the breaking pad being slid into the half-blade storage container with a sliding mechanism.

FIG. 12 is a side elevation view of an embodiment of a twin half-blade storage container attached to an embodiment of a breaking pad, according to the subject invention.

FIG. 13 is a side view of an embodiment of one half of a twin storage container having dual couplings, according to the subject invention.

FIG. 14A illustrates one embodiment of a blade extractor system of the subject invention.

FIG. 14B illustrates an embodiment of a blade extractor system of the subject invention where the blade conveyor is utilized to engage with a wrapped blade on the blade tray.

FIG. 14C illustrates an embodiment of a blade extractor system of the subject invention where the blade conveyor is utilized to advance a wrapped blade within the gutter of the blade tray.

FIG. 14D illustrates alternative prong embodiments, according to the subject invention.

FIG. 14E is a side view of an embodiment of a blade tray, according to the subject invention.

FIG. 14F is a side view of an embodiment of a blade tray, according to the subject invention, which illustrates a wrapped blade being advanced towards the prongs.

FIG. 14G illustrates an embodiment of a blade extractor system of the subject invention extracting a blade from a wrapper.

FIG. 14H is a side view of a blade conveyor having a magnetic securing structure with a blade attached.

FIG. 14I illustrates an embodiment of a blade conveyor of the subject invention being tilted against a surface, so that a blade coupled thereto is disengaged.

FIG. 14J illustrates an embodiment of a blade conveyor of the subject invention having a spindle hook for engaging with the spindle slot on a blade.

FIG. 15 illustrates an embodiment of a magnetic storage surface, according to the subject invention.

FIG. 16A illustrates an alternative embodiment of a blade breaking pad having a blade furrow.

FIG. 16B is an end elevation view of an alternative embodiment of a blade breaking pad having a blade furrow.

FIG. 17 is an embodiment of a blade breaking pad having a magnetic strip within a blade breaking furrow.

FIG. 18 is an embodiment of a blade breaking pad having a magnetic strip with spacers between breakable sections. Here a blade has been cracked and the individual half-blades are being attached to the magnetic strip.

FIG. 19 is an embodiment of a blade breaking pad having a continuous magnetic strip within the blade furrow that can be moved within the furrow.

FIG. 20 is an embodiment of a blade breaking pad in FIG. 19. Here the magnetic strip is shown with a half-blade attached and being moved to a side edge.

FIG. 21 is another embodiment of a blade breaking pad with a magnetic tab.

FIG. 22 is an embodiment of a magnetic tab.

FIG. 23 is an embodiment of a blade breaking pad that can be utilized with a magnetic tab.

FIG. 24 is an alternative embodiment of a blade breaking tab with a recessed slot for receiving a magnetic tab.

FIG. 25 is an alternative embodiment of a blade breaking tab with a recessed slot that does not extend to the crease.

FIG. 26 is an alternative embodiment of a blade breaking tab that can be utilized with a blade cassette.

FIG. 27A illustrates an embodiment of a blade cassette that can be utilized with the alternative embodiment of a windowed blade breaking pad shown in FIG. 26.

FIG. 27B illustrates an embodiment of a magnetic pad cassette that can be utilized with the alternative embodiment of a windowed blade breaking pad shown in FIG. 26.

FIG. 28A is a side elevation view of the embodiment of the windowed blade breaking pad in FIG. 26 with the embodiment of a blade cassette shown in FIG. 27A attached.

FIG. 28B is a side elevation view of an embodiment of the windowed blade breaking pad in FIG. 26, with an embodiment of a blade cassette and a magnetic pad cassette attached.

FIG. 29 is a top plan view of the embodiment shown in FIG. 28A.

FIG. 30 is a perspective view of the embodiment shown in FIG. 28A, as seen from the inside surface.

FIG. 31 is a top plan view of an embodiment of a blade guard attached to a blade.

FIG. 32 is a cross-sectional view taken along line A-A′ of FIG. 31, but without the blade in place, so as to show the insertion slots.

FIG. 33 is a side elevation view of the embodiment of a blade guard shown in FIG. 31, where the finger guards have been squeezed together to cause the blade to bow in one direction and the sheath to curve in the opposite direction.

FIG. 34 is a top plan view of an alternative embodiment of a blade guard having a frangible arm.

FIG. 35 is a cross-sectional view taken along line B-B′ of FIG. 34, but without the blade in place, so as to show the frangible arm.

FIGS. 36A, 36B, and 36C illustrate components of a safety razor blade and half-blade parts thereof. FIG. 36A shows an example of a whole blade. FIG. 36B shows examples of half-blades created from a whole blade. FIG. 36C illustrates an example of a typical wrapper used on a blade.

### DETAILED DISCLOSURE

The subject invention describes embodiments of devices and methods for breaking and storing razor blades. More specifically, the subject invention provides one or more embodiments of devices and methods that can be used by hand to safely and easily break razor blades and store the broken blade halves for later use. The embodiments described herein can be utilized independently or as part of an overall blade management system.

The following description and appended figures will disclose that the subject invention is useful in the field of medicine, particularly for dermatological procedures that utilize a razor blade. The embodiments of the subject invention are particularly applicable to the process of breaking safety razor blades for use in dermatological, or other medical, procedures. However, a person with skill in the art will be able to recognize numerous other uses that would be applicable to the devices and methods of the subject invention. While the subject application describes, and many of the terms herein relate to, a use for breaking and/or storing razor blades, other modifications apparent to a person with skill in the art and having benefit of the subject disclosure are contemplated to be within the scope of the present invention.

In order to provide a clear and consistent understanding of the specification and claims, including the scope to be given certain terms, the following definitions are provided.

As used herein, the terms “cracking” and “breaking” are used interchangeably to refer to any process or method of separating a blade, through the spindle slot (or serrated or perforated middle), into two longitudinal halves, where each half has one full sharp-edged side.

Also, as used herein, and unless otherwise specifically stated, the terms “operable communication,” “operable connection,” “operably connected,” “operable contact,” “cooperatively engaged,” “cooperative connection,” and grammatical variations thereof mean that the particular elements are connected in such a way that they cooperate to achieve their intended function or functions.

The present invention is more particularly described in the following examples that are intended to be illustrative only since numerous modifications and variations therein will be apparent to those skilled in the art. As used in the specification and in the claims, the singular for “a,” “an” and “the” include plural referents unless the context clearly dictates otherwise.

The various components described herein with a specific feature, structure, or characteristic related to a particular embodiment may be made of any material including, but not limited to, rubber, plastics, natural products, wood products, glass, metals, metal alloys, magnetic material, and combinations thereof, which is within the purview of one skilled in the art to affect such feature, structure, or characteristic of a particular component in connection with a related embodiment. The devices of the subject invention can also be formed of any of a variety of sterilizable materials. The devices of the subject invention can additionally be formed of any of a variety of materials that can be autoclaved. Thus, it should be understood that various modifications and substitutions of the materials of any components can be effected without departing from the scope of the invention itself.

Reference will be made to the attached figures on which the same reference numerals are used throughout to indicate the same or similar components. With reference to the attached figures, which show certain embodiments, it can be seen that the subject invention comprises devices and methods for breaking razor blades and/or storing broken blade halves. Certain embodiments can be used alone, while other embodiments are designed to function together. In general, the embodiments of the invention pertain to a blade breaking pad 100 with a compatible storage container 200; a twin half-blade storage container 300, a blade extractor system 400, magnetic storage strips, and a magnetic storage surface 500. Each of these embodiments, and variations thereof, can be utilized independently. However, two or more can be incorporated as part of a blade management system to safely and easily manipulate and store blades. To facilitate a better understanding of these embodiments, each will be described with sufficient detail as follows:

For clarity, it should also be understood that a whole blade 10 utilized with one or more embodiments described herein pertains, in general, to a standard, double-edged razor blade 10 having two sharp edges 12 on either side of a longitudinal spindle slot 14, two blunt ends 15, an upper blade surface 16, and a lower blade surface 19. FIG. 36A illustrates one embodiment of a typical double-edged razor blade. Such razor blades are also typically stored in individual wrappers 20, such as shown, for example, in FIG. 36C. For many procedures a razor blade is often “cracked” along the longitudinal spindle slot 14 to produce two half-blade 5 portions, each with one sharp edge 12 and two halves of the blunt ends 15, example of which are shown in FIG. 36B. The width (W) between the two sharp edges of a typical intact razor blade is approximately 2.1 cm and the length (L) between the blunt ends is approximately 4.3 cm. Certain embodiments of the subject invention are particularly efficacious when utilized with an intact, whole razor blade 10. Other embodiments can be utilized with one or both of the half-blade portions 5.

### I. Breaking Pad

One embodiment of the invention comprises a breaking pad 100. In general, a breaking pad is a device on which a blade 10 can be disposed and bent, so as to crack the blade. In one embodiment, a breaking pad 100 is a rigid or semi-rigid sheet 102 having at least one crease 104 at or about the middle of the sheet that allows the sheet to be folded into at least two panels 106. FIGS. 1 and 2 illustrated a non-limiting embodiment of a breaking pad. In a further embodiment, the sheet has an inside surface 108 and an outside surface 109. To crack a blade, such as, for example, the type shown in FIG. 36A, the lower surface 19 of the blade can be placed against the inside surface 108 of the sheet 102 with the longitudinal spindle slot 14 parallel to, and preferably approximately longitudinally centered on, the crease. An example of how a blade can be positioned on a breaking pad is shown in FIG. 3A. The blade can be in a wrapper 20, like the type shown in FIG. 36C, or it can be naked, as shown in FIGS. 3A and 36A, prior to placement on the breaking pad 100. The two panels 106 can then be folded, so that their inside surfaces come together and face each other, such as shown, for example, in FIG. 4. Bending the panels will simultaneously cause a blade thereon to bend. As the panels continue to be folded and their inside surfaces brought closer together, such as shown for example in FIGS. 4, 5, 6 and 7, the blade will continue to bend until the material exceeds critical tensile strength and cracks across the two blunt ends 15, resulting in two half blades 5, as shown, for example, in FIG. 36B. In a further embodiment, the outside surface 109 of the sheet can have any of a variety of ergonomic features 101 to assist with holding and/or bending of the panels. In a further embodiment, the crease 104 and/or the middle of the sheet 102 may constitute a living hinge or other hinge-like or related structure. FIGS. 2 and 5 illustrate embodiments of grasping pads 101 on the exterior surface that provide means for gripping the panels and that can also support the crease area against wear. Alternatively, the blade breaking pad 100 may be bent in half by squeezing either end of the panels 106 together towards the inside surface 108.

The circumferential shape of a sheet 102 can be any desirable functional shape. Likewise, the overall dimensions of a sheet can vary depending upon the functional shape chosen and other factors known to those with skill in the art. In one embodiment, a sheet is between approximately 6.0 cm. and approximately 12.0 cm in length and between approximately 5.0 cm. and approximately 12.0 cm in width. The slit can be located at any position on the sheet. In a particular embodiment, the slit is located at about half of the length. It is within the skill of a person trained in the art to determine an appropriate shape and size for a sheet. Such variations which perform the same function, in substantially the same way, with substantially the same result are within the scope of the subject invention.

The tensile strength of a blade can cause it to slide against the inside surface 108 when the panels are folded. This can prevent the blade from being properly bent and it can become dangerous, as a possible projectile. In one embodiment, the breaking pad 100 has one or more tracks 111 that prevent a blade from sliding. In general, a track is a raised area on the inside surface 108, against which the sharp edge of a blade can abut or otherwise be engaged, so as to inhibit sliding and hold the blade in place. The tracks may also be grooves, ridges, or guiding pins on the inner surface 109 of the pad 100.

In one embodiment, a track comprises a pair of elongated, raised areas on the inside surface of each panel 106. The tracks can be positioned along the width of each panel, so that a blade can be placed within a track furrow 112 therebetween and positioned as described above. Thus, the tracks can be substantially parallel to a crease 104 and sufficiently far apart to accommodate a blade. In a further embodiment, the tracks extend to about at least one side edge 103 of the sheet 102. A track can be formed as part of the sheet or can be a separate component placed on or added to the sheet. Any of a variety of materials, known to those with skill in the art, can be utilized for a track. Such alternatives are within the scope of the subject invention. Ideally, the track can comprise a material that is conducive to allowing a half-blade 5 to be slid against it, for purposes which will be described below. When the panels are folded, as shown in FIG. 7, the sharp-edges 12 of a blade placed within the track furrow 112 will abut against each of the tracks 111. If necessary, a finger can be placed on the blade as the panels are first folded, just to hold the blade in place until the sharp edges engage with the tracks. The blade can then be cracked, as described above.

In an alternative embodiment, a track can be a recessed area within the inside surface 108 of a panel that can receive the sharp edge of a blade. In a specific embodiment, there is a recessed on the inside surface of each panel. When the inside surfaces are brought closer together, the sharp edges 12 of the blade engage with the recessed tracks and are held in place as the blade bends and until it eventually cracks.

Once the blade is cracked, it can be helpful if the half-blades are held in place on the breaking pad, so they do not slide towards a side edge and can be more safely and easily picked up with the fingers. In one embodiment, one or both of at least the inside surfaces 108 of the panels 106 are comprised of a magnetic material, such as, for example, magnetized sheets, to which the half-blades can attach. In an alternative embodiment, the portion of the panels that form a track furrow 112 can comprise a magnetic material. In another alternative embodiment, a magnetic material can be fixedly attached to a track furrow 112.

With this embodiment, the panels can be brought closer together to crack a blade as usual. When the panels are separated, to allow access to the half-blades, the magnetized track furrow will hold the half-blades in place within the furrow. There are any of a variety of magnetized materials that can be utilized with the embodiments of the subject invention. A person with skill in the art would be able to determine one or more types of magnetized material that can be utilized with the embodiments of the subject invention. Such variations which provide the same function, in substantially the same way, with substantially the same result are within the scope of the subject invention.

Once a blade has been cracked, it may be desirable to store the resultant half blades for future use. It can also be desirable for the half blades to be handled no more than necessary, to reduce the likelihood of injury or contamination. Thus, it would be advantageous if the half-blades could be removed from the breaking pad to a storage device with minimal contact.

In a further embodiment, there is an elongated opening or slit 113 within the sheet that allows the two half blades to fall through the sheet when folded. In one embodiment, the slit is located at approximately the same location, and in approximately the same orientation, as the crease 104, such that the slit is between the two panels. In a particular embodiment, one side of the slit is in one panel and the other side of the slit is within the other panel. With this embodiment, the slit can actually replace, at least partially, the crease, such that a crease will be located at either end of the elongated slit. In a further embodiment, the slit 113 is located within the approximate center of the sheet, similar to the crease 104. In a still further embodiment, the length of the slit is greater than the length (L) of a blade, so that two half blades within the folded sheet can fall through the slit even if the half blades are not centered on the sheet 102. FIGS. 3 and 4 illustrate a sheet 102 having a slit 113 within the crease 104 at either end. When a sheet is folded along the crease and the blade is cracked, the blunt ends may not be flat and the broken edges can have a slight residual curve due to bending. In a still further embodiment, the width of the slit is sufficient to allow the blade halves to slide through even if the blunt ends are irregular or not flat. FIG. 5 illustrates an embodiment of a breaking pad 100 having a slit 113 and shows how a half blade 5 can drop through the slit.

To further encourage the half-blades to fall through the slit 113, a stop 110 can be positioned between the tracks and within the track furrow. FIG. 2 illustrates one example of this embodiment. The stops can prevent the half-blades from moving towards the side edges 103 of panels and can further ensure that they remain over the slit, so that they drop through more readily. FIG. 2 illustrates an embodiment of a breaking pad having dual stops 110 at either end of the slit 113 to prevent a half-blade thereon from moving away from the slit or towards the side edges 103. Any of a variety of devices or mechanisms can be utilized as a stop 110 according to the subject invention. Such variations which provide the same function, in substantially the same way, with substantially the same result are within the scope of this invention.

Sometimes several half blades are prepared in advance and stored for use. Thus, it can be beneficial for a sheet to have a slit, as described above, because the half-blades can simply be dropped into a storage container. However, sometimes half-blades are prepared just before use and are not meant to be stored. So, it can be preferable for the half-blades within a folded sheet to be held within the sheet until ready for use. When desired the half-blades can be picked up from the sheet. However, it can be more advantageous if the half-blades are moved to one edge of the sheet, so that they can be more easily grasped, reducing risk of injury.

With this embodiment of a blade breaking pad with a slit, the magnetized track furrow 112 and/or panels 106 described above could also be utilized. The magnetized area can ensure, for example, that the half-blades remain aligned with the slit and do not migrate to a side edge 103. In one embodiment, the magnetization of the track furrow can be sufficient to hold the half-blades in place, but not so strong that they are prevented from falling through the slit 113 when the pad is lightly tapped on a surface or lightly shaken to dislodge the half-blades so they fall through the slit. Alternatively, the slit could be utilized without a magnetized blade breaking pad.

In an alternative embodiment, there can be a slide mechanism 114 operably connected to the sheet that moves one or both half-blades to a side edge 103 for easier grasping and removal. In general, a slide mechanism is any device that can be operated to move a half-blade to or beyond a side edge so that a half-blade can be grasped with the fingers. The slide mechanism can operate with the sleeve completely or partially folded or when it is substantially flat or open. In one embodiment, the slit 113 is eliminated and the crease 104 runs the entire length of the blade breaking pad.

In one embodiment, a slide mechanism utilizes a slide button 116 within channel 118 located within a panel 106, an example of which is shown in FIG. 4. A channel can be substantially an elongated opening through a panel. The channel can also be sufficiently parallel to the crease 104 so that a slide button therein can be moved in a direction generally towards or away from a side edge 103. A slide button can have an exterior end 119 that extends through the channel to the exterior surface 109 of a panel, which can be manipulated by the fingers to move the slide mechanism within the channel, an example of which is shown in FIG. 1. The slide button can also have an interior end 120 that protrudes past the inside surface 108, so that it can make operable contact with a half-blade, such as shown, by way of example, in FIG. 3A. In a further embodiment, the slide button is affixed to the channel, so that it maintains slidable connection with the channel. In one embodiment, the slide button 116 is operably connected to a track 121 that secures the slide button within the channel and allows it to slide along most or all of the length of the channel. FIGS. 4, 5, and 6 illustrate one example of this embodiment. Alternatively, the shape of the slide button can be such that the exterior end 119 and the interior end 120 are larger in diameter than the channel, so that they cannot pass through the channel and some portion between the two ends slides within the channel. By way of non-limiting example, the slide button can have an hour glass-like shape, where the constricted center portion slides within the channel and the interior and exterior ends are the two enlarged ends. FIG. 7 illustrates an example of this embodiment. It would be within the skill of a person trained in the art to determine numerous alternative devices and methods for securing a slide button, or similar device within a channel. Such alternatives, which provide the same function, in substantially the same way, with substantially the same result, are within the scope of the subject invention.

In use, the slide button can be positioned at one end of the channel, so that a blade placed on the sheet will have the interior end 120 of the slide button at or about a blunt end 15 of the blade, such as shown, for example, in FIG. 3A. When the sheet is folded and the blade becomes cracked into two half-blades 5, they will, ideally, usually be planar with the inside surface 108 of the panels 106. The interior end 120 of the slide button will also be positioned next to a blunt end of the two half-blades, such as shown, for example, in FIG. 5. At this point, the slide button can be moved within the channel towards the blunt ends of the half blades, which will simultaneously push the half-blades towards a side edge of the panels. The length of the channel can dictate the maximum distance the half-blades are pushed towards the side edge. Ideally, the channel length allows the half-blades to be pushed towards a side edge sufficiently that at least one blunt end and some portion of the half-blade extend beyond the side edge. This will allow the half-blade to be grasped safely for use. FIG. 6 illustrates an example of this, where the slide button 116 is slid to one end of the channel 118 so that a half-blade is pushed past the side edge 103 of a panel 106.

If preferred, the panels of the sheet can be held slightly apart, or even completely flat, so that the interior end 120 of the slide button pushes against the blunt end of just one of the half-blades to slide just a single half-blade towards a side edge, such as shown, for example, in FIG. 3A. The slide button can then be moved back to the original position in the channel and the panels pushed closer together, so that the interior end 119 of the slide button is next to the blunt end of the second half-blade on the sheet. Again, the slide button can be moved towards a side edge of the panels, causing the second half-blade to extend beyond the side edge. In an alternative embodiment, a sheet 102 can include two slide mechanisms 114, one in each panel 106, such that each slide mechanism is used to move one, or, possibly, both, half-blades towards a side edge. In a further embodiment, the two slide mechanisms can be used to move each half-blade to opposite side edges.

While the breaking pad can be utilized with a naked blade, it is also possible to utilize the breaking pad with a blade still in the wrapper. However, once the blade is cracked into two half-blades, the wrapper can inhibit the half-blades from dropping through a slot or from being pushed to a side edge, as described above. It can be advantageous if the breaking pad includes a mechanism for cutting open the wrapper or otherwise disengaging the wrapper from the blade, so that the half-blades can be manipulated and or grasped safely.

A further embodiment includes a retractable wrapper cutting mechanism 250. A wrapper cutting mechanism can be utilized with a breaking pad 100 to cut open the wrapper 20 of a razor blade, so that the half-blades can be extracted more easily. In one embodiment, a retractable wrapper cutting mechanism comprises an elongated single-edge blade 252, similar to, for example, a scalpel blade. FIG. 3B illustrates an example of a single-edge blade 252. The single-edge blade 252 has a first end 253 that can be engaged with the slit 113 in a breaking pad and a second end 255 slidably attached to a groove 260 within one of the panels 106, such as shown, for example in FIG. 2. FIG. 3B illustrates one embodiment of a retractable wrapper cutting mechanism of the subject invention. In a further embodiment, the second end is fixedly attached to finger slide 262 that extends through the groove 260 and is accessible to the outside surface 109 of a panel 106. FIG. 1 illustrates an example of finger slide 262 within a groove 260. After a whole blade has been cracked in half with the breaking pad, the retractable wrapper cutting mechanism can be operated by utilizing the finger slide 262 to advance the single-edge blade within the groove 260 so that the first end 253 it is engaged with, by extending into, one end of the slit 113, so that the sharp edge is directed at or near one end of the wrapper 20. Once advanced and engaged, the single-edge blade can then be moved, via the groove, within the slit in the blade braking pad towards a side edge 103 and between the two separated half blades. As the cutting blade slides along the slit in the blade breaking pad, the wrapper is cut along its length thereby exposing the two half blades within. Once the wrapper is cut, the two half blades can fall through the slit 113, as depicted in FIG. 5. Afterwards, the wrapper cutting blade can be moved to its original position to be used again.

A further advantage of a wrapper cutting blade is that it can assist in curving the blade towards the crease, so that it cracks correctly. A blade placed within a blade breaking pad will be held in place usually by the tracks on the panels. However, if the blade has an undesirable bend or curve, when the panels 106 are brought closer together, the blade can bend away from the crease, which can be undesirable. However, with the embodiments of a wrapper cutting blade, as the panels are brought together, the cutting blade is positioned over the upper surface of the blade. Should the blade begin to bend away from the crease, the cutting blade 252 will inhibit the curve and ensure that as force is applied, the blade curves towards the crease 104.

FIG. 3B illustrates an embodiment having an L-shaped groove 260. Alternative embodiments can have grooves that are circular or semi-circular in shape. Still other alternative embodiments can have grooves with a combination of various curves and/or angles that allow the single-edge blade to be advanced towards and engaged with the slit. A person with skill in the art, having benefit of the subject disclosure, would be able to determine alternative devices and methods for cutting the wrapper of a blade on a breaking pad. It should be understood that such alternatives, which perform the same function, in substantially the same way, with substantially the same result, are within the scope of the subject invention.

In a further embodiment, a protective cover 270 can be disposed over the single-edge blade on the inside surface 108, to inhibit contact with the sharp edge of the blade. In one embodiment, a protective cover is a sheet of material that overlaps a portion of the inside surface and covers the groove 260. Ideally, the dimensions of the protective cover will be such that when the single-edge blade is not engaged with the slit 113, it can be retracted via the groove so that it is between the protective cover 270 and the inside surface 108. FIG. 3B illustrates an embodiment of a cover 270, according to the subject invention. In this embodiment, the protective cover is shown as a non-opaque material, such that the underlying components can be seen. It would be within the skill of a person trained in the art to devise alternative types of protective covers for a single-edge blade according to the subject invention. Such alternatives, which perform the same function, in substantially the same way, with substantially the same result, are within the scope of the subject invention.

### II. Modified Blade Breaking Pad

In an alternative embodiment, a modified blade breaking pad provides alternative devices and methods for breaking a blade 10 and transporting the resulting half-blades 5. One embodiment, utilizes a breaking pad having a blade furrow 151 between the two panels 106. With this embodiment, the panels can be moveably attached at or about a top edge 152 of each side of the blade furrow, as shown, for example, in FIGS. 16A and 16B. This allows the panels to be folded, so that their inside surfaces are brought together, as described above, but does not affect significantly the blade furrow. After a blade is cracked, the subsequent half-blades can fall into the blade furrow where they are more securely confined and can slide easily towards one side edge for disposal into a container or for grasping.

In one embodiment, a blade furrow can extend from one side edge 103 to the opposite side edge of a modified blade breaking pad. FIG. 16A illustrates an example of this embodiment. In one embodiment, a blade furrow has two parallel upright sides 154 each having a top edge 152 to which a panel 106 can be movably attached and an bottom edge 155 to which a floor 153 is attached and traverses between the upright sides. The depth of a blade furrow, from the top edge 152 to the bottom edge 155, can vary, but will ideally be such that it can hold at least two half blades that may be overlapping or stacked on top of each other. In one embodiment, the depth of a blade furrow is between approximately ⅛ inch and approximately ¼ inch. Thus, in a further embodiment, the width of a blade furrow, between the two upright sides is at least equivalent to the width (W) of a half-blade 5. While it can have a greater width, it should not be such that it adversely affects the ability of the modified blade breaking pad to crack a blade. Conversely, a blade furrow can have a narrower width, but should be sufficient to hold one or more half-blades in place for transport.

While the modified blade breaking pad makes it easier to control and manipulate half-blades into a container, on magnetic storage strips, or storage surface, as will be disclosed below, they must still be handled with the fingers prior to use. The thinness of a whole blade makes it difficult to pick up from a flat surface and the small size of a half-blade does not improve this situation. It would be helpful if the half-blades could be temporarily secured to some device that made it easier to hold and manipulate them prior to use. In one embodiment, a magnetic strip 156 is disposed within the blade furrow 151. The magnetic strip can cover some portion of the floor 153. When the half-blades fall into the blade furrow, they will automatically attach themselves to the magnetic strip. Ideally, the length of the magnetic strip is such that both of the half blades can attach themselves. For example, after a blade is cracked, the half-blades are usually side-by-side, so they usually fall together into the blade furrow. FIG. 17 shows an example of how a whole blade can be placed on a modified blade breaking pad, so that it is above the blade furrow, prior to being cracked. FIG. 18 shows an example of how the resulting half-blades can enter the blade furrow and attach to the magnetic strip. The modified blade breaking pad can be tilted slightly to cause the half-blades to slide apart and separate, so that each one can be attached to the magnetic strip. The magnetic strip, with the half-blades securely held thereon can slide out of the blade furrow at either side edge. At this point, the half-blades can be transported to where they will be used for a procedure. The magnetic strip and half-blades can also be stored for future use. Advantageously, the magnetic strip inhibits the half-blades from moving, so that they are always easy to transport and, when necessary, to grasp at the blunt ends 15.

Magnetic strips for use with the embodiments of the subject invention can be in the form of single units that are placed individually within a blade furrow. FIG. 17 illustrates one example of this embodiment. Alternatively, magnetic strips can be in a long strand or a roll, where individual magnetic strips are unwound and placed within the blade furrow. FIG. 18 illustrates this embodiment, showing the magnetic strips being continuous on one side. They can further have multiple separation points 161 that allow individual sections to be separated from the roll before or after the half-blades are attached. In a further embodiment, there is a spacer 157 between each magnetic strip on a roll, to facilitate separation and/or placement of the magnetic strips, again, an example of which is shown in FIGS. 17 and 18.

In some instances, half-blades are prepared as they are needed. Thus, it is not expected that the half-blades would be transported very far or that they would be stored on a magnetic strip 156. However, the use of a magnetic strip can still be utilized as a convenient way to temporarily hold the half-blades until ready to grasp for use. One embodiment of the subject invention utilizes a continuous magnetic roll 158 of material that slides within the blade furrow. With this embodiment, the magnetic strip, with or without spacers, is in the form of a continuous loop that is contained within and can slide through the blade furrow and loops around the exterior surface 159 of the floor 153. FIG. 19 shows one example of this embodiment. In a further embodiment, the bottom surface has one or more guides 160 that keep the continuous magnetic roll 158 aligned with the blade furrow. FIGS. 16B and 19 illustrate examples of guides 160 that can be utilized with the embodiments of the subject invention.

With this embodiment, after a blade is cracked, the half-blades can enter the blade furrow. The continuous magnetic roll can be moved, such as by pushing it or pulling it with a finger so that it slides along within the blade furrow, until the blunt end of a half-blade extends out over one of the side edges 103 of a sheet 102, such as shown, for example, in FIG. 20. This allows the half-blade to be securely grasped by one end to be easily removed from the magnetic roll, which can be much safer than handling a loose blade.

### III. Slotted Breaking Pad

With the blade breaking pad 100 embodiments of the subject invention, a whole blade, either wrapped or unwrapped, can be placed between the tracks 111, which can help hold a blade in place, and the panels folded to crack the blade. As demonstrated by the embodiments of a modified blade breaking pad 150 described above, it can be helpful for the resulting half-blades to be secured while still in the blade breaking pad. An alternative embodiment utilizes a magnetic tab that can be used to place a blade in a proper position on a blade breaking pad and also be used to remove the resulting half-blades afterwards.

In one embodiment, a blade breaking pad is modified with a slot 371 that bisects one of the tracks 111. The slot allows for a magnetic tab 375 to slide along the inside surface 108 of a panel 106, so as to place a blade 10 in the proper position to be cracked. This embodiment also allows for the resulting half-blades to be easily removed from the slotted breaking pad 370, by sliding the magnetic tab through the slot 371 or by just lifting the magnetic tab from the slotted breaking pad 370.

In one embodiment, a slotted breaking pad 370 is similar to a breaking pad 100 as described above, where there are two panels 106 having opposing side edges 103 and joined by a crease 104 that allows the inside surfaces 108 of the panels 106 to be folded and brought closer together. Each panel can have a track 111 thereon that extends from one side edge to the other side edge, such that the tracks are substantially parallel to the crease and are placed a sufficient distance from the crease that a blade can be placed therebetween with the longitudinal spindle slot 14 aligned with the crease.

In a further embodiment, a first panel 106A has a track 111 that extends from one side edge 103 to the opposite side edge 103 and a second panel 106B has a similar track, but which has a portion removed to form the slot 371. FIG. 21 illustrates one example of this embodiment, where the track 111 on the second panel 106B has a slot 371 therethrough.

The slot 371 allows a magnetic tab 375 to slide along the inside surface 108 of the second panel 106B and past the track 111 to position a blade attached thereto within the track furrow 112 and over the crease 104. In one embodiment, a magnetic tab 375 is a substantially flat, rigid, or at least semi-rigid, structure. A handle end 377 is designed to be held in the hand in order to slide it along the inside surface 108. Thus, the handle end can have any of a variety of shapes or ergonomic structures that aid in holding and manipulating the magnetic tab.

In a further embodiment, a magnetic pad 378 can be fixedly attached to the handle end, such that the handle end can be used to slide or otherwise place the magnetic pad, and a blade thereon, over the crease 104. A magnetic pad should have dimensions that allow it to slide through the slot 371 and still securely retain a blade, wrapped or unwrapped, thereon, so that it can be placed within the track furrow 112 of the slotted breaking pad 370. In a specific embodiment, the blade is placed on an upper surface 376 of the magnetic pad such that when placed within the track furrow, the magnetic pad is against the crease 104. FIG. 21 illustrates one example of this embodiment, where a magnetic tab 375 is positioned within the slot 371 and is holding a blade over the crease. A magnetic pad can comprise a magnetic material that is fixedly attached to the handle end. A magnetic pad can also comprise a magnetic material attached to another material that is fixedly attached to the handle end. Still further, the handle end can be extended and a magnetic material affixed to the extended portion. FIGS. 21 and 22 illustrate one embodiment of a magnetic tab according to the subject invention. A person trained in the art would be able to determine any number of methods and devices by which a magnetic pad can be fixedly attached to, made part of, or otherwise extend from the handle end. Such variations, which provide the same function, in substantially the same way, with substantially the same result, are within the scope of the subject invention.

Because the magnetic pad will remain within the track furrow 112 it will be folded between the panels along with the blade. While it is desirable for the blade to crack when folded or bent, it is preferable for the magnetic pad 378 to remain intact and capable of being used to remove the resulting half-blades from the slotted breaking pad 370. In one embodiment, the magnetic pad comprises a flexible material that is amenable to being bent or folded without itself breaking or cracking. Alternatively, the magnetic pad can have a fold line 379, such as shown, for example, in FIG. 22, that allows it to fold without damage as the blade cracks.

In a further embodiment, a guard 380 is fixedly attached to the magnetic tab 375. The guard can act similarly to a track 111 in that it can aid in holding a blade, in position on the magnetic pad, to prevent the blade from sliding upwards or turning sideways as the panels are folded together. In one embodiment, the position of the guard on the magnetic tab is between the handle end 377 and the magnetic pad 378. FIG. 22 shows an example of a guard 380 fixedly attached to a magnetic tab 375. In a more specific embodiment, the guard 380 is located on the magnetic tab in a position that will cause it to be approximately parallel, preferably, collinear with the track 111 on either side of the slot 371, when the magnetic pad is placed within the track furrow 112, an example of which is shown in FIG. 21. This can ensure that, should the blade move off the magnetic pad, each sharp edge 12 can still be secured by the tracks 111 and/or the guard 380. In general, a guard 380 is a raised area on or about the area of the magnetic pad 378, against which the sharp edge of a blade can abut or be otherwise engaged, so as to inhibit sliding and hold the blade in place. Alternatively, the guard can be one or more ridges or guide pins aligned parallel to the crease. A guard can be formed as part of the magnetic pad or magnetic tab or a guard can be a separate component fixedly attached to the magnetic tab.

In one embodiment, a guard 380 comprises a material that allows a half-blade 5 to slide against it, for purposes which will be described below. In a further embodiment, a guard comprises a material that is similar to or the same as a track 111, described above.

To ensure that a blade is properly cracked, it is important that the blade be properly positioned on the breaking pad. The advantage of a slotted breaking pad is that it can ensure that a blade is properly positioned on a breaking pad and is securely held before the cracking procedure is initiated. To further ensure that the blade is in the proper position, there can be a recess 382 within the slot 371 with which the magnetic tab 375 can be cooperatively engaged, to ensure that the magnetic pad 378, and a blade thereon, is properly aligned in the furrow and the crease 104. FIG. 23 shows one example of a recess 382 in the panel 106 of a breaking pad where the recess extends across the entire first panel 106A, through the slot 371, into the track furrow 112, and to the track 111 in the second panel 106B. In one embodiment, the recess 382 is a depressed area on the inside surface 108 of a panel 106. In one embodiment, the dimensions of the recess allow the entire magnetic tab 375 to be placed therein and slide towards the furrow, as shown, for example, in FIG. 24. In an alternative embodiment, the dimensions of the recess can be such that it extends only partially across a panel so that the magnetic tab engages only partially with the recess. For example, a recess can extend only partially across a first panel to the slot 371, an example, of which, is shown in FIG. 25.

The breaking pad embodiments of the subject invention can be advantageously utilized to break at least one blade at a time into two half-blades. The breaking pad can also have features that allow it to be utilized for effectively moving the half-blades to an appropriate storage container, by allowing the half-blades to slide through a slit without contact or utilizing magnetic strips to secure the half-blades to a safe surface. If the half-blades are not intended for storage, the breaking pad can also be utilized to temporarily hold the half-blades and then move the half-blades into a position where they can be easily and safely grasped for use.

### IV. Half-Blade Storage Containers

Once a blade has been cracked, the two half blades can be either used immediately for a procedure or they can be stored for later use. It is not uncommon for a multitude of half-blades to be prepared in advance and stored for later use. This can save time later and reduce the possibility of injury by cracking a blade during a procedure.

Typically, half-blades are stored in loose condition in some type of container. This method necessitates reaching into the container and trying to grasp a single half-blade. Needless to say, inserting one's fingers into a container of sharp half-blades really negates the whole reason for creating the half-blades in advance. Conversely, whole blades are often stored in a safety container with a bias-spring that juxtaposes the blades with their upper and lower surfaces flat against each other in the container. A safety container can also have a razor access slot that allows a single blade at a time to be pushed or forced out of the slot in a container. Such storage containers are known in the art and are a safe and convenient way to store multiple razor blades. It would be a great advantage if half-blades could be stored in a similar type of container.

One embodiment of the subject invention comprises a half-blade storage container 200. A half-blade storage container can be similar to a whole blade storage container, in that it can hold half-blades in a stacked manner and allow them to be extracted similarly as described above. In one embodiment, a half-blade storage container is a chamber having a top wall 203, a bottom wall 204, two side walls 206, and a front wall 207 and a rear wall 208, which define a hollow interior 210, with dimensions thereof that are compatible with those of a half-blade, as will be understood below. In one embodiment, the shape of the walls assists in maintaining the alignment of the half-blades within the hollow interior. Typically, because half-blades tend to be rectangular in shape, a storage container 200 can also be rectangular, or otherwise box-shaped. However, it can have any desirable shape that is conducive to storage of half-blades and does not necessarily have to be rectangular. FIG. 8 illustrates one embodiment of a half-blade storage container according to the subject invention.

To store one or more half-blades in a half-blade storage container 200 necessitates that they be introduced into the container in an easy and safe fashion and so their upper and lower surfaces are juxtaposed with the container. In a further embodiment, the front wall 207 has a blunt end slot 209 into which half-blades can be inserted one at a time, by their blunt ends. In a further embodiment, the length of the blunt-end slot between the two side walls, is at least equivalent to the (W) of a half-blade 5, which is illustrated, for example, in FIG. 8. This can allow a half-blade to be pushed into the blunt-end slot by inserting a blunt end 15, aligned with the blunt-end slot, and pushing the half-blade until it slides entirely into the container 200.

In a further embodiment, a biasing element 212 is positioned within the interior 210 to assist in maintaining the juxtaposition of the half-blades and to assist in removal of stored half-blades from the chamber. In one embodiment, a biasing element is a device that applies force against one surface of a half-blade, so that it is held against a surface of a juxtaposed blade or towards the top wall 203 if it is the top-most blade within the container 200. In one embodiment, a biasing element can be a spring mechanism having a first end buttressed against a wall, such as, for example, the bottom wall, and a second end capable of pushing, directly or indirectly, against a surface of a half-blade. In a specific embodiment, a biasing element is a curved or bent strip of material having one side buttressed against the bottom wall 204 and a second side that pushes, directly or indirectly, against a surface of a half-blade. FIG. 8 illustrates one example of this alternative embodiment. These and other types of biasing elements are known in the art and a person with skill in the art would be able to determine any variety of such elements for use with the embodiments of the subject invention. Such variations, which provide the same function, in substantially the same way, with substantially the same result are within the scope of the subject invention.

To use one of the stored half-blades, it will be removed from the half-blade storage container, preferably in a safe fashion with minimal opportunity for injury. A whole-blade storage container usually employs a cut-out in the container within the surface against which the blades are biased. The cut-out can partially expose a surface of a blade. By pressing and sliding a finger or some other device over the cut-out and towards the blunt-end slot, the frictional force will slide a blade towards the blunt-end slot, causing it to at least partially exit the blunt-end slot, for grasping.

Likewise, one embodiment of the subject invention utilizes a cut-out 214 within the top wall 203 that can be utilized to make contact with an upper most blade in the container and slide it towards the blunt-end slot 209. FIGS. 8 and 11 illustrates an example of this embodiment. A slot can be located in any location on the top wall. A cut-out can also be located at the side of the top wall and can further extend to include part of a side 206. It would be within the skill of a person trained in the art to determine the appropriate location and dimensions for a cut-out. Such variations are within the scope of the subject invention.

In an ideal situation, it would be possible for a blade to be cracked and the individual half-blades inserted into a half-blade storage container 200 with minimal or no contact with the fingers. This can reduce injury, maintain cleanliness of the blades, and can be more efficient. It would be further advantageous if a half-blade storage container could be utilized with a breaking pad 100, such that half-blades on the breaking pad could be disposed within a half-blade storage container directly from the sheet 102 and/or panels 106.

In one embodiment, two half-blade storage devices are rotatably coupled to form a twin storage container 300, one example of which is shown in FIG. 9A. In a further embodiment, two half-blade storage devices have a rotatable coupling 301 at or about their top wall edges 205, so that their bottom walls and side walls can swing apart, such as shown, by way of example, in FIG. 10B, so that there is an adjustable angle therebetween. This embodiment further allows their blunt-end slots 209 to swing apart, as shown in FIGS. 10A and 10B, allowing an adjustable angle 316 therebetween as well. Half-blade storage containers can be rotatably coupled by any one of a variety of devices or methods. Ideally, such coupling will be durable, flexible, and easily incorporated with half-blade storage containers. In a specific embodiment, a living hinge is utilized to rotatably couple the two half-blade storage containers. In an alternative embodiment the coupling may be detachable, breakable, or otherwise separable, allowing the two halves of the twin storage container to be divided and used independently after being filled. It would be within the skill of a person trained in the art to determine an appropriate coupling device or method for use with the embodiments of the subject invention. Such variations which perform the desired functions are within the scope of the subject invention.

Advantageously, embodiments of a twin storage container can be utilized cooperatively with a breaking pad 100, so that half-blades can be disposed directly into each half 317 of a twin storage container from the breaking pad, with minimal or no contact with the fingers. The breaking pad can be utilized, as described above, to crack a blade. Once the blade is cracked, a twin storage container 300 can be placed against a side edge 103 of the panels 106 on a breaking pad 100, so that each of their blunt-end slots 209 is between a track 111 and the crease 104 of the breaking pad and juxtaposed with the track furrow 112. With this embodiment, the breaking pad can be utilized without stops 110, which are mentioned above. FIGS. 11 and 12 illustrate one example of this embodiment. In a further embodiment, a slide mechanism 114 cooperatively attached to a panel 106 can be used as described above to move the half-blades 5, simultaneously or one at a time, to a side edge 103 of the panel 106, where the blunt ends 15 of the half-blades encounter the blunt-end slots 209 on the twin storage container 300. The slide mechanism can further be utilized to push the blunt end 15 of the half blades at least partially into the twin blade container. FIG. 11 illustrates an example of this procedure, wherein the slide mechanism is used to push a half-blade partially into the blunt-end slot of one half of a twin storage container.

In order to slide a half-blade into one half 317 of a twin storage container from a breaking pad, the twin storage container, as mentioned above, can be placed against a side edge of the breaking pad. The twin storage container can be held with one hand against the side edge, while the sliding mechanism is utilized with the opposite hand. In one embodiment, each half 317 has one or more notches 218 that can be used to help align and hold the blunt-end slots with the breaking pad. One or more notches can slide over and/or under the side edge of a panel to align and secure each half of the twin storage container against the breaking pad. FIG. 11 illustrates one embodiment of a twin storage container with such notches 318 near the blunt-end slot. However, it can still be difficult to manipulate the twin storage container against the side edge and simultaneously utilize the slide mechanism. Thus, it can be helpful if the twin storage container can be cooperatively engaged with the breaking pad, so that it maintains the proper position for the slide mechanism to push one or both half-blades into the blunt-end slot.

In one embodiment, each half of a twin storage container is equipped with dual couplings 319 that fit over a side edge. In a further embodiment, there is an upper coupling 319A and a lower coupling 319B that mount over the side edge to engage with the inside surface 108 and the outside surface 109, respectively. FIG. 13 illustrates one example of this embodiment. With the dual couplings on each half 317 supporting a twin storage container, it can be easier to manipulate the slide mechanism, as discussed previously.

In a further embodiment, the breaking pad has a thin tab 220 that helps to guide a half-blade 5 into a twin storage container. FIG. 4 illustrates one embodiment of a tab 220 according to the subject invention. The tab can be fixedly attached to the inside surface 108 and/or to one or both of the tracks 111 so that it extends over the track furrow 112. A tab can be a unitary structure with a bend in the middle that extends across most or all of a track furrow, such as shown, for example, in FIG. 3A. Alternatively, there can be two or more tabs that extend over each side of a track furrow, such as shown, for example, in FIG. 1. In one embodiment, the tab is positioned over the track furrow so that it can guide or direct a half-blade into a blunt-end slot. A half-blade within the track furrow can be advanced towards the side edge of a sheet. When the half-blade approaches the tab, the leading blunt end 15 can slide under the tab, so that the half-blade is between the tab and the sheet 102. It can be preferable for a tab to be rigid or at least semi-rigid, so that it maintains a position over the track furrow and does not bend or deform undesirably when contacted with a half-blade. As mentioned above, one or both of the blunt-end slots 209 can be positioned against a side edge so that each one is between a track 111 and the crease 104 of the breaking pad and juxtaposed with the track furrow 112. This necessarily causes the tab to guide the half-blade into the blunt-end slot as it is advanced with the slide mechanism, mentioned above. Advantageously, the breaking pad tab 220, such as shown, for example, in FIGS. 4 and 5 can also hold the whole blade in place and can also force it to bend downward upon squeezing of the blade breaking pad panels 106. This can eliminate the need to use a finger to hold the blade and encourage the proper direction of bending, as mentioned above. In a slightly alternative embodiment, a whole blade can be positioned within the track furrow with a blunt end 15 slightly tucked under the tab, so that when the blade is cracked, the half-blade blunt ends are already engaged under the tab. Thus, referring to FIG. 3A, the blade shown thereon can be moved towards the side edge, so the blunt end is covered by the tab. After the blade is cracked, the blunt ends of the half-blades will be between the tab and the sheet and pre-aligned with the blunt-end slots.

### V. Combined Blade Breaking Storage Containers

A twin storage container 300, as described above in detail, can be used to store half-blades 5 in a safe and convenient manner. In one embodiment, a twin storage container can be used with a blade breaking pad 100 to slide half-blades directly from the breaking pad into the twin storage container. The advantages of this system are that a razor blade 10 can be broken and stored with minimal or no contact with the fingers.

In an alternative embodiment, a twin storage container 300 can be adapted to crack whole blades therein and automatically store each half blade in one half of a twin storage container. This adaptation of a twin storage container provides a blade breaking storage container 350 that can safely crack a blade 10 into two half-blades 5, which can be automatically stored within each of the half-blade storage containers 200 that make up a blade breaking storage container 350.

In one embodiment, a blade breaking storage container 350 is similar to a twin storage container 300, in that, it comprises two half-blade storage containers 200, as shown in FIG. 8 that have a rotatable coupling 301, as previously described, for a twin storage container, an example of which is shown in FIGS. 9A and 10A. In a particular embodiment, the top walls of two half-blade storage containers are rotatably coupled 301 by a living hinge.

In an embodiment of a blade breaking storage container, the blunt-end slots 209 on the rotatably coupled half-blade storage containers are modified so that they form a continuous blade aperture 355 in a blade breaking storage container 350. In this embodiment, the side walls 206 that face each other do not extend all the way to the top wall 203, and example, of which, is shown in FIGS. 9B and 10B. This can provide a blade aperture 355 that extends across a front wall 208 and extends to the rear wall 208. FIGS. 9B and 10B illustrate one example of this embodiment, wherein the two facing side walls 206, do not extend to the top wall.

With this embodiment, the blade breaking storage container can be situated with the two half-blade storage containers 200 side-by-side, so that the entire length of the blade aperture 355 is horizontal, as shown, for example, in FIG. 9B. At this point, a whole blade can be inserted, blunt end 15 first, into the blade aperture 355 until the blade is completely within the blade breaking storage container 350. To break the blade 10, the two half-blade storage containers of a blade breaking storage container can be forcibly swung apart, at the rotatable coupling 301, so that their facing side walls 206 form an angle therebetween, and the blade aperture 355 separates as well. This action also forces the rotatably coupled edges 205 of the top wall 203 connected by the rotatably coupling, to move towards the blade aperture, applying force to the blade therein. One example of this is shown in FIG. 10B. A blade within the blade breaking storage container will be forced to bend and will eventually crack as the facing sidewalls are moved further apart and the top wall edges continue to move towards the blade aperture 355. In one embodiment, when the blade cracks, the two resulting half blades are each automatically aligned with, or become otherwise cooperatively engaged with, each half-blade storage container of the blade breaking storage container. The rotatably coupled edges of the top walls 205, illustrated, by way of example, in FIG. 9B, can also be modified to facilitate cracking of a blade. In one embodiment, the top wall edges 205 are modified with a sharp edge 360 as shown, for example, in FIG. 10B. In one embodiment, the top wall edges 205 are beveled, honed or formed a sharp edge. In another embodiment, a rigid panel or reinforcement can be fixedly attached to a top wall edge. A person with skill in the art would be able to determine any one of a variety of options that can be used to enhance the ability of a top wall edge to crack a blade. Such modifications which perform the same function, in substantially the same way, with substantially the same result are within the scope of the subject invention.

This embodiment, allows a whole blade to be inserted into a blade breaking storage container, wherein it can be safely cracked into two half-blades. Advantageously, the two resulting half-blades are immediately in a position to be safely and conveniently stored within the half-blade containers that make up a whole blade breaking storage container. Further, a whole wrapped blade can be utilized with the blade breaking storage device by unwrapping just a blunt end portion. The exposed blunt end can be inserted into the blade aperture and the wrapped blade portion can be pushed against the blade breaking storage container until the whole blade is within the aperture. The resulting empty crumpled wrapper can be discarded after the blade is pushed fully into the device. This method can significantly inhibit any contact with the blade and the sharp edges 12, as well as inhibit contact with the blade while it is cracked and with the resulting two half-blades. The blade breaking storage device provides a safe, convenient, inexpensive, and reusable product for cracking and storing blades.

The above-described embodiments illustrate the advantages of utilizing a blade breaking pad to crack a blade. Certain embodiments also demonstrate the advantages of utilizing a blade breaking pad cooperatively with blade storage containers. In particular, certain embodiments of the subject invention, as described above, allow a blade to be broken and inserted into a storage container without having to contact the half-blades with the hands. To fully implement a hands-free system, however, would necessitate methods and devices by which a blade can be disposed onto a blade breaking pad and cracked without the hands having to contact the blade. The following embodiments of a windowed breaking pad and compatible cassette can provide such advantageous devices and methods.

VI. Windowed Breaking Pad with Cassette

One embodiment of the subject invention is a windowed breaking pad 600 that can be utilized cooperatively with a blade cassette 700. In one embodiment, the blade cassette 700 can be operatively connected to the windowed breaking pad 600, so that individual blades within the cassette can be extracted by the windowed breaking pad and automatically disposed within the track furrow 112 of the windowed breaking pad. In a further embodiment, the blade cassette can be operatively connected to the windowed breaking pad, so that the blades therein can be continuously extracted.

A windowed breaking pad 600 can be substantially similar to the breaking pad embodiments, described above, where it has a sheet 102 comprising a first panel 106A and a second panel 106B, each panel having an inside surface 108 and an outside surface 109 and which are joined at a crease 104. The windowed breaking pad can further have tracks 111, as described above. Embodiments of a windowed breaking pad can also include other features which have been described previously with regard to a breaking pad 100, a modified breaking pad 150, and a slotted breaking pad 370.

In one embodiment, a windowed breaking pad 600 has a window 610 within a first panel 106A that communicates the outside surface 109 with the inside surface 108. In a further embodiment, the dimensions of the window 610 are compatible with those of the front face 710 of a blade cassette, so that the front face can be operatively engaged with the window. FIG. 26 illustrates one embodiment of a windowed breaking pad 600 according to the subject invention.

Utilized in conjunction with a windowed breaking pad is a blade cassette 700. A blade cassette is essentially a storage container for blades, such as, for example, those described above, but, which has been modified to operate with a windowed breaking pad. A blade cassette can typically comprise a top wall 712, a bottom wall 714, as well as two side walls 716 and a back wall 718 that join together the top wall and bottom walls, providing, substantially a box or box-like form with a hollow chamber 720.

Blade storage containers having a biasing element 212 for urging blades against one surface of the hollow interior 210 of a storage container have been discussed above and such biasing elements are applicable to embodiments of a blade cassette 700. In one embodiment, a blade cassette contains multiple whole blades 10 that are stacked, one against another, within the blade cassette, i.e., upper blade surfaces 16 against lower blade surfaces 19. In a further embodiment, the blade cassette has a front face 710 against which the stored blades are urged, by means of the biasing element. With this embodiment, an upper blade surface 16 is pressed against the front face 710 from within the hollow interior 720. FIG. 27A shows an example of a blade cassette with a stored blade being urged against the front face 710.

In order to extract blades from the blade cassette, there needs to be an appropriate opening within the cassette. Preferably, the opening allows blades to be extracted individually. In one embodiment, the bottom wall 714 has a sharp-edge slot 730 through the bottom wall 714 and at or near the front face 710. In one embodiment, the sharp edge slot extends approximately from one sidewall 716 to the other and has a width capable of allowing a single wrapped or unwrapped blade to pass, sharp-edge 12 first, from the hollow chamber. FIGS. 27 and 30 illustrate such an embodiment.

In a further embodiment, the front face 710 is divided by two or more conduits 724 that communicate the hollow interior with the outside of the blade cassette. In one embodiment, a conduit is substantially parallel to the side walls 716, as shown in the example in FIG. 27A. This allows one or more slider pins 805, to be discussed below, to traverse through the conduit and make contact with a blade urged against the front face.

For the blade cassette to operate optimally, the front face 710 will be properly aligned with the window 610, as well as the inside surface of the first panel 106A. This can be accomplished by holding the blade cassette against the window. Various external structures on the outside surface 109 of the first panel can assist in aligning the window and the blade cassette. However, it can be advantageous for the blade cassette to be secured against the first panel, without having to hold it in place.

In one embodiment, the blade cassette has two slide flanges 728 attached to each of the sidewalls 716. Side flanges can be singular structures or multiple aligned structures on each side of the blade cassette. In a further embodiment, the slide flanges are arranged parallel to the front face 710 of the cassette, as shown, by way of example, in FIG. 27. The first panel 106A can be modified with one or more structures to which the side flanges can be removeably attached. In one embodiment, the first panel has two receiver brackets 620 positioned on either side of the window 610. In a further embodiment, the receiver brackets are positioned on the first panel so that they can removeably receive the slide flanges on a blade cassette. For example, in an embodiment, where the window 610 is rectangular or square, the receiver brackets can be parallel to the sides of the window and perpendicular to the crease 104. This allows the blade cassette to be removably attached to the windowed breaking pad by sliding the front face 710 on the outside surface so as to couple the side flanges with the receiver brackets, such as shown, for example, in FIGS. 28A and 29. Once coupled together, the side flanges and receiver brackets are able to maintain the front face 710 within the window 601.

It should be understood that slide flanges can be positioned anywhere on the outside surface 109, depending upon a variety of factors that would be understood by a person skilled in the art, such as, for example, the shape of the blade cassette. Such variations, which perform the same function, in substantially the same way, with substantially the same result, are within the scope of the subject invention.

In a further embodiment, one or more stays 625 are used to prevent the blade cassette from sliding out of or otherwise coming uncoupled from the receiver brackets. A stay 625 can be generally any structure that inhibits movement of the blade cassette. For example, a stay can be any type of extended surface feature that essentially blocks movement of the cassette in one or more directions. In a particular embodiment, the position of a stay on the outside surface 109 assists in aligning the front face 710 of the blade cassette with the window 610. FIG. 26 shows one example of a stay 625 positioned between two receiver brackets and at one end of the window, such that the stay prevents a blade cassette from sliding towards the crease and helps hold the blade cassette in place within the window. A person with skill in the art would be able to determine an appropriate stay for use with the embodiments of the subject invention. Such variations in stay designs that provide the same function, in substantially the same way and provide substantially the same result, are within the scope of the subject invention.

Once a blade cassette is properly aligned with the window 610, a blade 10 can be dispensed from the blade cassette. Ideally, a blade can be dispensed from the blade cassette and delivered into the track furrow 112 to be cracked. To facilitate movement of the blade into the track furrow, the track 111, or some portion thereof, on the first panel can be removed to provide a pathway 630 from the blade cassette to the track furrow, an example of which is shown in FIG. 30.

To remove or dispense a blade from the cassette, the blade most closely urged against the front face can be pushed or slid out of the sharp-edge slot 730. This can be facilitated by a variety of techniques, including, but not limited to, sliding a finger over the conduits with sufficient pressure to contact the blade and, by frictional force, slide it out of the sharp-edge slot.

Alternatively, an end track 640 can be employed to remove a blade from a blade cassette 700 through the sharp-edge slot 730. In one embodiment, an end track 640 is slidable affixed to the inside surface 108 of the first panel. In a further embodiment, an end track is an elongate member 642 that operates with a rail mechanism, as shown, by way of example, in FIG. 28A.

A rail mechanism can comprise at least one track 654 to which one or more sliders 646 can be operably connected. In one embodiment, two tracks 654 can be fixedly attached to the inside surface 108 of the first panel 106A. The two tracks can be positioned generally perpendicular to the crease 104 and with one on either side of the window 610, such as shown, for example, in FIGS. 28 and 29. In a further embodiment, at or about each end of the elongate member 642 is at least one slider 646 that operatively connects with a track, such that the slider can move on the track. Likewise, when the elongate member is moved, the at least one slider on either end move simultaneously.

FIG. 29 illustrates a view looking down the outside surface of a first panel towards the crease and shows one embodiment of the subject invention. It can be seen that with this embodiment, a track 654 comprises a channel 655 into which the slider can be emplaced. In a further embodiment, a track overlaps at least part of a slider 646, so that the overlapped part of the slider can slide and be confined within the length of the channel. In a particular embodiment, a track overlaps and encroaches into a constriction on a slider, so as to confine the slider within the track.

There are any of a variety of rail mechanisms that can be utilized with the embodiments of the subject invention. It is within the skill of a person trained in the art to determine any of a particular type of rail mechanism that would be applicable for use in the subject invention. Such variations, which perform the same function, in substantially the same way, with substantially the same result, are within the scope of the subject invention.

An end track 640 can be employed as a mechanism for extracting a blade 10 from a blade cassette and placing it within the track furrow. In one embodiment, an end track can be positioned above the top wall, when the blade cassette is in place within a window. FIGS. 29 and 30 provides an illustration of one example of this embodiment. In a further embodiment, fixedly attached to the elongate member 640 is one or more dowel pins 670 that protrude into the conduits 724 within the front face 710 of the blade cassette, when the blade cassette is placed within a window. When the end track is moved towards the crease, by means of the one or more sliders moving through one or more tracks, the one or more dowel pins encounter one sharp edge of the blade urged most closely to the front face 710. As the end track continues to move towards the crease, the one or more dowel pins 670 slide through the one or more conduits, simultaneously pushing opposite short edge of the blade towards the sharp-edge slot 730. Continued movement of the end track causes the one or more dowel pins to push the blade entirely out of the blade cassette. At this point, the blade can slide on its own or be assisted by hand into the track furrow 112.

Alternatively, the length of the one or more tracks can allow the end track to push a blade entirely into the track furrow. In one embodiment, one or more tracks, fixedly attached to the inside surface can extend towards the furrow such that when the elongate member is pushed fully towards the crease 104, the dowel pins 670 will push a blade into position with a track furrow.

As discussed previously, when a blade is cracked within the breaking pad embodiments of the subject invention, it can possibly slide on the inside surfaces when the panels are brought together. In one embodiment, tracks 111 can be utilized to inhibit sliding and hold the position of a blade for cracking. However, with the windowed breaking pad embodiments, a portion of the track on the first panel can be removed to provide slidable access to the track furrow.

Advantageously, the end track 640 can be utilized as a mechanism for replacing the track portion that is removed to provide a pathway 630 to the track furrow. In one embodiment, the rail mechanism 650 can have a length that allows the elongate member to be moved towards the crease until it is substantially collinear with the remaining track portions on either side of the pathway 630 on the first panel. If there are no track portions on the first panel 106A, then the end track can be pushed towards the crease until the blade is between and abutted against the track on the second panel 106B and the end track 640. The end track can also be held in place against a blade by any of a variety of devices or techniques known to those with skill in the art. In one embodiment, there is a snap-fitting engagement between the end track and another component that temporarily holds the end track in place while a blade is being cracked. This allows the dowel pins 670 and/or the end track to assist, along with the track 111 on the second panel 106B in holding the blade in place while being cracked.

Certain embodiments described above utilize magnetic strips to hold blades in place on a blade breaking pad. The magnetic strips provide a surface to which blades can attach for safer and easier handling. In an alternative embodiment, a blade cassette, or similar device, can be employed as a storage device for multiple magnetic pads 950, which can be similar to and perform the same function as magnetic strips. In one embodiment, magnetic pads are single, flat magnetic pieces to which one or more half-blades can attach. They can be any size, but ideally can provide a surface or platform on which one or more half-blades can affix for safe and convenient transport or storage. Preferably, they can have a flexible construction that allows them to be bent, curved, or otherwise temporarily deformed, so that when utilized with a blade breaking pad, they do not crack like a razor blade.

In one embodiment, the magnetic pad cassette 900 can be substantially similar to a blade cassette, in that it can be connected to a windowed breaking pad. A magnetic pad cassette 900 can also be structurally similar to a blade cassette by having a top wall 912, a bottom wall 914, as well as two side walls 916 and a back wall 918 that join together the top wall and bottom walls, providing, substantially a box or box-like form with a hollow chamber 920. A magnetic pad cassette can further have a biasing element 212 for urging blades against a front face 910 from within the hollow chamber 920, as similarly discussed above. In a further embodiment, the front face 910 is configured with one or more conduits 924, similar to those employed with a blade cassette 700. Still further, a magnetic pad cassette can have a sharp-edge slot 930 through the bottom wall 914 and at or near the front face 910. In one embodiment, the sharp edge slot extends approximately from one sidewall 916 to the other and has a width capable of allowing a magnetic pad to pass from the hollow chamber 920. FIG. 27B illustrates one example of a magnetic pad cassette 900, according to the subject invention.

In one embodiment, a magnetic pad cassette 900 can be used to store multiple magnetic pads 950 that are stacked, one against another, within the magnetic pad cassette like blades, i.e., upper surfaces against lower surfaces. The magnetic pads 950 can have any desired dimensions that would be suitable for use with the embodiments of the subject invention. A magnetic pad cassette can also have any dimensions that would be suitable for use with magnetic pads and with a windowed blade breaking pad. In a specific embodiment, the magnetic pads and magnetic pad cassette have dimensions similar to those of a blade and blade cassette. In a further embodiment, the magnetic pad cassette has a front face 910 against which the stored magnetic pads are urged, by means of the biasing element, similar to the blades as discussed above. FIG. 27B shows an example of a magnetic pad cassette of the subject invention with a stored magnetic pad being urged against the front face 910.

A magnetic pad cassette can function with a windowed breaking pad 600 in substantially the same way as a blade cassette, wherein the magnetic pad cassette 900 can have one or more slide flanges 928 that can be engaged with one or more receiver brackets 620 on a windowed breaking pad. In a further, embodiment, the magnetic pad cassette can operate with a rail mechanism 650 also as described above with regard to a blade cassette. In one embodiment, one or more dowel pins 670 protrude into the conduits 924 within the front face 910 of the magnetic pad cassette, when the magnetic pad cassette is placed within a window. When the end track 640 is moved towards the crease, by means of the one or more sliders 646 moving through one or more tracks 654, the one or more dowel pins encounter one edge of a magnetic pad urged most closely to the front face 910. As the end track continues to move towards the crease, the one or more dowel pins 670 slide through the one or more conduits 924, simultaneously pushing the opposite site of the magnetic pad towards the sharp-edge slot 930. The end track can continue to be pushed towards the crease until a magnetic pad is fully dispensed from the magnetic pad cassette and deposited into the track furrow.

An alternative embodiment of a breaking pad can have two windows, one in each panel 106A and 106B, an example of which is shown in FIG. 28B. With this dual-window breaking pad 975, a blade cassette 700 can be operably connected to one window and a magnetic pad cassette 900 can be operably connected to the other window. This can allow a magnetic pad to be first dispensed into a crease from the magnetic pad cassette. Once the magnetic pad is in place, a blade can be dispensed, as described above, from a blade cassette and deposited over the magnetic pad. The panels can then be brought together to crack the blade. The panels can be opened or separated to allow access to the resulting half-blades, which are conveniently secured to the intact magnetic pad 950. The magnetic pad can then be retrieved with the fingers and the half-blades thereon transported to the area of use or stored on the magnetic pad for later use.

### VII. Breakable Blade Guard

The use of blades, whole and half-blades, for surgical procedures is well-known in the art and has several advantages. Blades are inexpensive, disposable, and allow precise control. Manipulation of a blade, particularly the most commonly used half-blade, during a medical procedure can, however, be difficult. Blades and half-blades, even at the blunt ends 15 by which the half-blades are usually held in the fingers, are thin. This thinness can make holding and manipulating them uncomfortable for the fingers and potentially dangerous. Further, when a blade is curved for use, it has a potential energy force that can cause it to become a dangerous projectile if it is accidentally released from the fingers. U.S. patent application Ser. No. 13/653,687 (Allyn) describes several embodiments of blade guards that can be used to assist with grasping and manipulating a blade. The embodiments of U.S. patent application Ser. No. 13/653,687 (Allyn) can make medical procedures more comfortable and safer to perform. U.S. patent application Ser. No. 13/653,687 (Allyn) is hereby incorporated by reference, in its entirety, including any figures appended thereto, such that the embodiments therein are not inconsistent with the teachings of the subject application.

The subject invention provides an additional embodiment of a blade guard 800 that can be used advantageously with the various blade breaking pad embodiments of the subject invention. A blade guard can make holding and manipulating a blade easier and more convenient. More importantly, a blade guard can be a safety feature that protects the sharp edge 12 of a blade against accidental contact.

In one embodiment at least one blade guard 800 is attached to a whole blade 10. In a further embodiment, the combined blade and at least one blade guard is placed on one of the blade breaking pad embodiments of the subject invention. When the blade is cracked with a blade breaking pad, as described herein, the resulting half blades can have firmly attached to them one blade guard 800. The use of the blade breaking pad, which can apply force to the blade guard while cracking the blade, can also ensure that the blade guard is firmly attached to the blade. Thus, the blade breaking pad can be integral to securely attaching a blade guard onto a blade and any resulting half-blades. Alternatively, a blade can first be cracked with a blade breaking pad of the subject invention and a blade guard attached to one of the resulting half blades.

Typically, a half-blade 5 is squeezed between the fingers to form a bowed shape, directed away from the finger tips, that is used for a medical procedure. Advantageously, the blade guard 800 can cover the sharp edge and can also bend in the opposite direction to the half-blade, allowing the half-blade sharp edge 12 to be available for use. Embodiments of blade guards of the subject invention can also provide finger guards 820, fixedly attached thereto and that cover the blunt ends, so that the half-blades can be grasped more easily and safely.

In one embodiment, a blade guard 800 has one or more finger guards 820 into which at least a portion of the blunt end 15 of a blade can be inserted. A finger guard can be engendered with any of a variety of shapes, such as, for example, ergonomically advantageous or aesthetically appealing shapes. In general, a finger guard can have a facing side 822, directed at or about the same direction as the sharp edge; an insertion side 826 having also an insertion slot 827 for receiving the blunt ends 15 of a blade; a blade side 828, that faces towards, or in the direction of the blade and towards the blade side of a finger guard, when present on the opposite end of the blade, such that the blade sides generally face each other; and a finger grip 830, facing approximately opposite to the blade or in a direction conducive to grasping and squeezing a blade. A finger guard can further comprise a top end 832 which defines the proximal end 870 of a finger guard and a bottom end 834 that defines the distal end 875 of a finger guard. FIGS. 31, 32, and 33 illustrate one embodiment of a blade guard according to the subject invention.

In a further embodiment, a sheath 850 is fixedly attached to and extends from a finger guard and covers at least the sharp edge of a blade operatively connected to the finger guard. When two or more finger guards are present, a sheath can be fixedly attached at either end and extend between the finger guards to cover at least the sharp edge of a blade operatively connected to each of the finger guards. In one embodiment, the sheath is proximal 870 to the insertion slot 827, such that a half-blade will be distal to the sheath when the finger guards are in use. FIGS. 30 and 32 illustrate one example of this embodiment, where a blade is operatively attached between two finger guards and a sheath covers and protects the blade operatively connected, by means of the insertion slots, between the two finger guards.

With reference to FIGS. 31, 32, and 33, a sheath can have a variable width (W), but ideally is sufficiently wide to protect the sharp edge from incidental or accidental contact. In one embodiment the sheath extends past the sharp edge to inhibit contact from the facing side 822 of the blade guard. In one embodiment, the sheath is a substantially flat, flexible member that is substantially planar to a blade in a blade guard, when the finger guards are not being squeezed. U.S. patent application Ser. No. 13/653,687 (Allyn), hereby incorporated by reference in its entirety, describes finger guard and blade guard embodiments that can be utilize with embodiments of the subject invention.

As described above, at least one blade guard, preferably two blade guards, can be operably attached to each of the sharp edges of a whole blade. When the whole blade is cracked in a blade breaking pad of the subject invention, each resulting half-blade can have a blade guard securely attached over the sharp edge. In one embodiment, the blade breaking pad is utilized to firmly secure the blade guards to each side of a blade and ensure that they are in place after the blade is cracked, making handling of the resulting half-blade easier and safer. When the half-blades are not in use, the sheath covers or overlaps the blade inhibiting contact with the sharp edge. In use, the finger guards over each blunt end 15 of a half-blade can be squeezed together to cause the blade to bow with the desired curvature for use. Simultaneously, as the blade bows away from the fingers, the sheath 850 bends in the opposite direction, towards the fingers, which exposes the more distally curved sharp edge for use. Should the half-blade accidentally slip out of the fingers, becoming substantially a dangerous projectile, the half-blade will automatically and instantaneously lose curvature and become straight, which will simultaneously cause the sheath to do the same and cover the sharp edge of the blade.

In a further embodiment, where two blade guards are utilized, the finger guards across from each other on a blunt end can be fixedly connected by a frangible arm 875, such as shown, for example, in FIGS. 34 and 35. A frangible arm can extend across the blunt end from one finger guard 820 to the opposite finger guard 820, effectively joining them together. The frangible aim can prevent the blade guards from being accidentally disconnected from a whole blade. This can make whole blades easier and safer to store and the blade guards make the blades easier to manipulate, particularly when placing them in blade breaking pads.

In a further embodiment, the frangible arms 875 can be broken when the blade is cracked by the blade breaking pad, allowing the half-blades to be used separately. In one embodiment, the frangible arms comprise a material that has a limited flexibility. The limited flexibility allows the frangible arms to bend or flex during normal blade storage and manipulation, but when exposed to the extreme bending caused by a blade breaking pad, the material breaks, cracks, shatters, or otherwise separates, along with the blade, to provide two half-blades with blade guards operably connected thereto.

In an alternative embodiment, the frangible arms 875 can have a break zone 877 that allows the frangible arm to break in a desired location. A break zone can be a weak area of the frangible arm that allows the arm to flex and bend in one direction, but causes it to break when force is applied in another direction. In a specific embodiment, a frangible arm can be a plate-like member 879 that extends between the finger guards, such that the plate-like member is perpendicular to the blunt end of the blade, as shown, by way of example, in FIG. 3. When force is applied to the flat sides of the plate-like member, the frangible arm bends or flexes in response. However, when force is applied from a proximal 870 direction, such as occurs in a blade breaking pad, the frangible arm cracks, just like the whole blade, providing the two half-blades with operably connected blade guards.

### VIII. Blade Extractor

Razor blades utilized for surgical procedures are often packaged individually in a paper wrapper 20. The individual wrapping prevents injury when handling the blade and helps maintain the cleanliness of the blade. The usual wrapper comprises a rectangular center 22 and at least four tabs—two short end tabs 24 and two long side tabs 26, an example of which is shown in FIG. 36C. During packaging, a blade is placed on the center 22 portion and the two end tabs are folded over the blunt ends 15 of the blade, followed by the two side tabs, which fold over, one overlapping the other and each overlapping the two end tabs, such as shown, by way of example in FIG. 14A.

In order to use a razor blade, the wrapping must usually be removed to expose one or both of the sharp edges 12. While this can be done by hand, simply by unfolding the tabs, it exposes the fingers to contact with a raw blade and can cause contamination of the blade, particularly if injury results. Embodiments of the subject invention provide a blade extractor system 400 and method for removing a blade from a wrapper without the fingers making contact with the blade. Advantageously, the blade extractor system 400 can be utilized in conjunction with the breaking pad 100 described above and with a blade storage surface 500, or magnetic strips, which will be described below.

A blade extractor system 400 of the subject invention includes at least two components: a blade tray 410 and a blade conveyor 450. FIG. 14A illustrates one embodiment of a blade tray and a blade conveyor, according to the subject invention. In general, the blade tray provides a surface on which a blade can be placed and structures that can engage with the wrapper and remove it. The blade conveyor, in general, is utilized to engage the wrapped blade with the structures on the blade tray, which assist the blade conveyor with opening the wrapper. The blade conveyor can also couple with the blade simultaneously with the unwrapping process, so that the blade is held securely and untouched by the fingers for transport to the next stage of use.

In one embodiment, a blade tray 410 is generally a flat member with an upper surface 414 on which parallel bumpers 418 are secured, as shown in the embodiment in FIG. 14A. For purposes of description herein, the blade tray can also have a proximal end 401 and a distal end 402. The dimensions of a blade tray can be such that the at least one wrapped blade can be placed substantially flat thereon and between the two bumpers. In one embodiment, the upper surface 414 of the blade tray comprises a smooth surface that allows a wrapped blade to slide between the two bumpers.

In a further embodiment, dual bumpers 418 are affixed to the upper surface and extend in parallel fashion from the proximal end 401 to the distal end 402, so that a gutter 403 is formed between them. The bumpers can be employed as guides when a blade is placed within the gutter and moved across the upper surface 414, as illustrated, by way of example, in FIG. 14B. In one embodiment, the distance between the bumpers is such that a gutter therebetween is approximately equivalent to, or slightly greater than, the width (W) of a wrapped blade. In a more particular embodiment, the gutter has a width between the bumpers of between approximately 2.1 cm and 3.0 cm. In a specific embodiment, the gutter has a width between the bumpers of approximately 2.2 cm. A bumper can comprise any material against which a wrapped blade within the gutter can slide or be pushed. Further, a bumper can comprise a unitary structure or can be multiple components that are aligned or are coplanar to guide a blade therebetween. Such variations are within the skill of a person trained in the art and are within the scope of the subject invention.

A wrapped blade placed within the gutter can slide across the upper surface 414, as will be described below, so that it encounters one or more structures for engaging with and assisting with removing the wrapper and exposing the blade. In one embodiment, the one or more structures utilized to remove the wrapper are one or more prongs 420 that are fixedly attached at about the distal end 402 of the blade tray. Ideally, at least two prongs are utilized. In a further embodiment, a prong is an elongated, rigid, rod- or flange-like structure having a first end 421 that is fixedly attached and a second end 422 that is unattached. The purpose of a prong is, generally, to engage with the tabs of a wrapper as it slides within the gutter across the upper surface. Ideally, at least two prongs are utilized so that each can assist in separating the side tabs 26 to open the wrapper, so that the blade can be extracted.

In one embodiment, the first end 421 of a prong is fixedly attached. A prong can be fixedly attached to the blade tray and/or a bumper. Alternatively, a prong first end can be attached to another structure that is itself fixedly attached to the blade tray and/or a bumper. Preferably, the first end is fixedly attached, by whatever means, in such a way that it maintains the first end of the prong securely and prevents the prong from rotating or moving when force is applied thereto, which can adversely affect the operation of the second end 422. This type of attachment can be accomplished by any variety of devices or techniques known to those with skill in the art. Such variations are within the scope of the subject invention.

In a further embodiment, the second end 422 of a prong is positioned so that it is located within the gutter, or within the path of a wrapped blade within the gutter. Thus, a prong can be located within a gutter or the area near a gutter, such as at the distal end 402 of a gutter. Alternatively, the second end of a prong can at least partially extend past, around, or otherwise traverse beyond the distal end 400 of a bumper, so that the second end is positioned within the gutter or within the gutter area. FIGS. 14C and 14D illustrate non-limiting examples of prong embodiments, according to the subject invention.

In a further embodiment, at least the second end 422 of the prong is raised above the upper surface 414, so that at least the second end is not in contact with the upper surface, such as shown, for example, in FIGS. 14E and 14F. The distance that the second end is raised above the upper surface should be gauged so that when a wrapped blade within the gutter slides towards the second end of the prong, also within the gutter or gutter area, the second end goes over the end tab 24 of the wrapper. FIGS. 14E and 14F are side views of a blade tray that illustrate an example of this embodiment, wherein one of the bumpers has been removed to show the gutter and prong details. Further, the prong can extend into the gutter a sufficient distance that it can engage with a side tab nearest the bumper that the prong traverses, as shown, for example, in FIG. 14A.

In a particular embodiment, two prongs are utilized so that each one engages with a side tab, on each side of a wrapper. In one embodiment, the second end of a prong extends approximately perpendicular to a bumper, such that it protrudes straight into the gutter. In an alternative embodiment, the second end of a prong extends generally parallel to a bumper, non-limiting examples of which are shown in FIG. 14D. However, since one or more prongs are utilized to engage with and assist in removing the wrapper from a blade, it can be beneficial if the prongs are positioned to maximize their effectiveness in separating the side tabs 26. In a particular embodiment, the second end of two prongs are positioned at angles, relative to a bumper, so that they form a wedge-shape within the gutter or gutter area, an example of which is shown in FIGS. 14B and 14C. Thus, the angle of the two prongs can direct their second end towards the center of the gutter area, so they form a wedge-shape between them that can engage with the side tabs of a wrapper and, as the wrapper advances onto the prongs, can help to separate the side tabs, exposing the blade thereunder.

A blade tray can be held in place by hand as the wrapped blade slides across the upper surface. However, the blade tray can also include one or more securing structures 430 or devices that maintain the position of a blade tray on a surface, such as a table or countertop. This can allow the blade extractor system to be employed with one hand, if necessary. In one embodiment, the securing structure is at least one magnet attached to the blade tray to secure it to a surface. This allows the blade tray to be moved to different locations. Alternatively, a blade tray can be permanently attached to a surface by an adhesive product. In yet another alternative, a blade tray can be secured with any one or more of a variety of other components. Alternatives which provide the same function, in substantially the same manner, with substantially the same results are within the scope of the subject invention.

As mentioned, the blade extractor system 400 of the subject invention operates by engaging the wrapper on a blade with the at least one, ideally, at least two, prongs on a blade tray. This necessitates a wrapped blade being advanced onto the second end of the prongs. While this could be done by hand, it would leave the unwrapped blade exposed at the distal end of the blade tray. To resolve this problem, the blade extractor system of the subject invention can include a blade conveyor 450.

In one embodiment, a blade conveyer has an elongated body 452 having a flat tip 455. When a wrapped blade is disposed within the gutter, the flat tip is capable of being inserted between the end tab 24 at the proximal end 401 and the proximal end of the two, overlapping side tabs on the blade wrapper, as shown, by way of example, in FIG. 14B. The length of the body can vary, but can desirably be long enough to slide completely from one end tab to another end tab, beneath the side tabs of a wrapper, such as shown, for example, in FIG. 14C. As mentioned above, the blade conveyor can be used to advance a wrapped blade towards the prongs. The blade conveyor can further have a handle 457 or handle-like structure that can be used to facilitate advancement of the wrapped blade towards the prongs.

In a further embodiment, a blade coupling device 460 is incorporated with the body 452 of the blade. As will become evident below, the blade conveyor can be coupled with or can be coupled to the unwrapped blade when it reaches the distal end of the blade tray. Ideally, the coupling process can be automatic and potentially error-proof, so that the exposed blade does not have to be handled with the fingers. It can also be beneficial if coupling of the blade can be conveniently undone without using the fingers.

In one embodiment, the coupling device has a magnetized portion 461 on the bottom side 453 of the blade conveyor body that can engage with a blade 10. In one embodiment, all or most of the blade conveyor body is magnetized. In an alternative embodiment, only a portion of the blade conveyor body is magnetized. The partially magnetized portion can be located anywhere on the blade conveyor body. FIG. 14H illustrates one example of a partially magnetized portion. It can be beneficial if the location of the magnetized portion allows the blade conveyor body to couple with the blade without interfering with the ability of the blade conveyor to advance the wrapped blade within the gutter and assist with unwrapping the blade.

It can also be beneficial if the blade can be uncoupled from the magnetic securing device 460, without touching the blade. In one embodiment, the magnet has a flat coupling surface 462 that couples with the blade. When the blade is coupled to the securing device, it can be transported to another surface for further use. By placing the blade against a surface and tilting the blade conveyor, the magnetic portion can be disengaged from the blade, so that it remains on the other surface. In a further embodiment, the magnetic surface can be confined to the central portion of the body, such that the edges of the blade are not magnetized. This can aid in disengaging the blade from the flat coupling surface 462 when the body is tilted. FIGS. 14H and 14I illustrate one example of this procedure, where a blade is pressed against a surface 550 and the blade conveyor is tilted to disengage the magnetic securing structure from the blade.

An alternative embodiment of the blade coupling device 460 is a spindle hook 463. A spindle hook can operate similarly to a magnetized portion 461. A spindle hook can also be located in approximately the same area on the bottom side 453 of a blade conveyor body 452. In one embodiment, a spindle hook is a flange or finger-like extension from the bottom side of the blade conveyor that points towards the flat tip 455. FIG. 14J shows on example of a spindle hook that can be utilized with embodiments of the subject invention. A spindle hook can cooperatively engage with the longitudinal spindle slot 14 on a blade 10, when the blade conveyor is used.

When the blade conveyor is inserted under the tabs, the resistance therebetween allows the wrapped blade to be pushed within the gutter towards the distal end of the blade tray. Often, the side tabs 26 are held closed by a small amount of adhesive applied during the manufacturers wrapping process, which can aid in this process. FIG. 14B illustrates an embodiment of a blade conveyor initially engaged with a wrapped blade with the flat tip 455 under the overlapping side tabs. When the blade conveyor advances the wrapped blade sufficiently to engage the prongs, several events can occur simultaneously as the blade continues to advance towards the distal end 402. FIG. 14C shows how the flat tip of an embodiment of a blade conveyor contacts the distal end tab 24 of a wrapped blade within a gutter and advances it towards the prongs. FIG. 14G illustrates an example of how the prongs engage the side tabs 26, providing resistance against the wrapper, so that as the blade conveyor continues to advance the wrapped blade, the prongs force the distal ends of the side tabs to separate. Prongs arranged in a wedge-shape, as mentioned above, can be particularly advantageous for this purpose. But, alternative prong arrangements are also possible and within the scope of this invention. The resistance of the prongs can also cause the flat tip 455 to push against the distal end tab causing it to fold out, as shown in FIG. 14G.

As the blade conveyor continues to advance, the blade coupling device cooperatively engages with the blade. In one embodiment, the magnetic portion thereof couples with the blade. Once this occurs, the blade conveyer with the blade coupled thereto can be lifted from the blade tray, extracting the blade from the now opened wrapper. FIG. 14G illustrates an example of a blade conveyor with a blade coupled thereto being removed from the wrapper. At this point, the blade is securely held and capable of being easily transported or being safely grasped for use.

In an alternative embodiment, as the blade conveyor advances, the spindle hook engages with the spindle slot and slides towards and abuts against one end of the spindle slot 14. In a further embodiment, the length of the spindle hook is such that when it engages with the end of the spindle slot 14, it protrudes sufficiently towards the blunt end 15 that when the blade conveyor is lifted away from the blade tray, the unwrapped blade 10 will be lifted as well. In one embodiment, the length of the spindle hook will allow the blunt end 15 of the blade nearest to the spindle hook to tilt towards and abut against the bottom side 453 when the blade conveyor is lifted away from the blade tray, allowing the blade to also be lifted away from the blade tray.

To disengage the spindle hook, it simply needs to be moved back within the spindle slot and lifted away from the blade. This provides the advantage of not having to press the blade against anything to disengage, as with the magnetic portion described above.

Other types of blade coupling devices can also be utilized with the embodiments of the subject invention. For example, more than one spindle hook can be used; a spindle hook could be used in addition to a magnetic portion; devices that conform to the shape of the spindle slot can be used; adhesive surfaces could be utilized; and other devices and methods known to those with skill in the art. Such modifications which perform the same function, in substantially the same way, and provide substantially the same result are within the scope of the subject invention.

### IX. Magnetic Storage Surface

Half-blades prepared for intended later use can be difficult to store. Often, they are deposited into an open container from which they will later have be grasped or poured out onto another surface to grasp. All of these techniques have a potential for injury to the fingers and contamination of the half-blades, and can simply be inconvenient. Previously described embodiments utilize convenient magnetic strips as a storage apparatus for blades. Further embodiments of the subject invention provide a solution to this problem with a magnetic storage surface 500 on which one or more half-blades, or whole blades, can be conveniently held for temporary or long term storage and from which blades can be easily grasped. A magnetic storage surface can be used alone or in conjunction with magnetic strips.

In one embodiment, a rigid or semi-rigid platform of any desirable dimensions having a generally flat upper face 510 with magnetic properties can retain one or more blades 10 or half-blades 5. Because blades and half-blades are flat and thin, it can be difficult to pick them up with the fingers from a flat surface. Thus, it could be difficult to grasp a blade from the magnetic upper surface if it is completely flat. In one embodiment, the upper surface is configured with one or more magnetic areas 520 that are raised above the level of the upper surface 510. When a blade or half-blade is disposed on a magnetic area, one side of the blade, ideally a blunt end, can protrude over one side of the magnetic area, causing it to be raised above the level of the upper surface. FIG. 15 illustrates one embodiment of a magnetic storage surface with multiple blades thereon. Also shown in FIG. 15 is a blade placed with a blunt end off of the magnetic surface. This can make grasping the blade easier and still retain the blades securely against the magnetic storage surface 500. Advantageously, both wrapped and naked blades can be utilized with the magnetic storage surface, as shown in FIG. 15.

A further advantage is that the magnetic storage surface can be utilized with the blade extractor system to store blades extracted from their wrappers. The blade conveyor can also be conveniently used to transport a blade from the blade tray to a breaking pad 100. When the blade conveyor is tilted to uncouple a blade, as described above and as shown in FIG. 14I, it can be directly transferred to the magnetic surface area 520 or to a breaking pad without any contact with the fingers.

The embodiments of the subject invention described herein provide convenient, easy to use devices and methods for manipulating and storing razor blades. Further, the embodiments of the invention provide devices that require minimal or no contact of the fingers with razor blades. The ability to safely crack a blade in half and store it in a convenient way is a vast improvement over the current methods of cracking blades, essentially, within the fingers, and storing them en masse in an unsafe manner. While the embodiments herein can be used or sold individually, the advantages of the subject invention can be most appreciated when the embodiments are purchased and/or utilized together as part of an overall safe blade handling system. Thus, it should be understood that the various embodiments of the subject invention can be utilized alone or can be part of an overall system comprising two or more of the embodiments disclosed herein. When utilized together, the embodiments of the subject invention make it possible to manipulate a blade from the unwrapping process through the blade breaking and storage processes without any contact with a blade whatsoever. The subject invention provides a vast improvement over current safety and cleanliness procedures and the devices are simple and easy to use and store.

All patents, patent applications, provisional applications, and other publications referred to or cited herein are incorporated by reference in their entirety, including all figures and tables, to the extent they are not inconsistent with the explicit teachings of this specification. Additionally, the entire contents of the references cited within the references cited herein are also entirely incorporated by reference.

Any reference in this specification to “one embodiment,” “an embodiment,” “example embodiment,” “further embodiment,” “alternative embodiment,” etc., is for literary convenience. The implication is that any particular feature, structure, or characteristic described in connection with such an embodiment is included in at least one embodiment of the invention. The appearance of such phrases in various places in the specification does not necessarily refer to the same embodiment. Further, when a particular feature, structure, or characteristic is described in connection with any embodiment, it is within the purview of one skilled in the art to affect such feature, structure, or characteristic in connection with other ones of the embodiments.

The invention has been described herein in considerable detail, in order to comply with the Patent Statutes and to provide those skilled in the art with information needed to apply the novel principles, and to construct and use such specialized components as are required. However, the embodiments of invention can be carried out by specifically different equipment and devices, and various modifications, both as to equipment details and operating procedures can be effected without departing from the scope of the invention itself. Further, although the present invention has been described with reference to specific details of certain embodiments thereof and by examples disclosed herein, it is not intended that such details should be regarded as limitations upon the scope of the invention except as and to the extent that they are included in the accompanying claims.

I claim:

1. A blade breaking pad, for cracking a razor blade into half-blades, comprising:
a sheet having an inside surface, an outside surface, at least one side edge, where the sheet is divided by a crease that allows the sheet to be folded into a first panel and a second panel, such that the inside surface of the panels can be brought together;
a first track fixedly attached to the first panel and a second track fixedly attached to the second panel wherein the first and second tracks are parallel to the crease and form a track furrow on the inside surface into which a razor blade can be placed, such that one or more sharp edges of the razor blade can operably contact at least one of the first track and the second track.

2. A blade breaking pad according to claim 1, further comprising a slit parallel to and within the crease that allows a half blade to fall through.

3. A blade breaking pad according to claim 2, further comprising a wrapper cutting mechanism that comprises:
a groove within the first panel of the sheet,
a wrapper cutting mechanism comprising,
an elongated single-edge blade having a first end and a second end,
a finger slide fixedly attached to the second end of the sharp blade and moveably attached to the groove, wherein the finger slide is accessible from the outside surface of the first panel;
such that sliding the finger slide within the groove moves the first end of the single-edge blade towards and partially through the slit and such that continued sliding of the finger slide within the groove will cause the single-edge blade to cut a wrapper on a blade within the blade breaking pad and will hold the whole blade in place for breaking.

4. A blade breaking pad according to claim 3, further comprising a protective cover on the inside surface of the first panel that covers the groove and single-edge blade.

5. A blade breaking pad according to claim 4, further comprising one or more stops within the track furrow to prevent the blade or half-blades from moving to the at least one side edge.

6. A blade breaking pad according to claim 2, further comprising one or more gripping pads fixedly attached to the outside surface of a sheet.

7. A blade breaking pad according to claim 6, wherein at least the inside surfaces of the sheet is magnetized.

8. A blade breaking pad according to claim 7, wherein at least the track furrow is magnetized.

9. A blade breaking pad according to claim 2, further comprising a slide mechanism comprising:
a channel through the first panel;
a slide button having an exterior end and an interior end and operably connected to the channel, wherein the exterior end is accessible from the outside surface and the interior end is positioned within the track furrow, so that when the slide button is moved by the exterior end through the channel, a blade or half-blade within the track furrow is moved to a side edge of the sheet.

10. A blade breaking pad according to claim 9, wherein the slide button moves a blade or half-blade to the side edge sufficiently that a blunt end can extend past the side edge.

11. A blade breaking pad according to claim 9, wherein at least the blunt end of the half-blade can be inserted into a storage container.

12. A blade breaking pad according to claim 10, further comprising one or more tabs overlapping the track furrow, wherein the tabs help guide the blade or half-blade towards the side edge.

13. A blade breaking pad according to claim 12, further comprising one or more gripping pads fixedly attached to the outside surface of a sheet.

14. A blade breaking pad according to claim 13, wherein at least the inside surfaces of the sheet is magnetized.

15. A blade breaking pad according to claim 13, wherein at least the track furrow is magnetized.

16. A method for cracking a razor blade into two half-blades utilizing a blade breaking pad comprising:
a sheet having an inside surface, an outside surface, at least one side edge, where the sheet is divided by a crease that allows the sheet to be folded into a first panel and a second panel, such that the inside surface of the panels can be brought together;
at first track fixedly attached to the first panel and a second track fixedly attached to the second panel wherein the first and second tracks are parallel to the crease and form a track furrow on the inside surface into which a razor blade can be placed, such that one or more sharp edges of the razor blade can operably contact at least one of the first track and the second track,
the method further comprising:
placing a blade into the track furrow so that one or more sharp edges of the blade are parallel to the first track and the second track;
folding the first panel and second panel so that the inside surfaces are brought closer together; and
squeezing the first panel and second panel together so that their inside surfaces are against one another, causing the blade to crack.

17. A method according to claim 16, further comprising a slit parallel to and within the crease that allows a half blade to fall through.

18. A method according to claim 17, further comprising a wrapper cutting mechanism that comprises:
a groove within the first panel of the sheet,
an elongated single-edge blade having a first end and a second end,
a finger slide fixedly attached to the second end of the sharp blade and moveably attached to the groove, wherein the finger slide is accessible from the outside surface of the first panel;
the method further comprising sliding the finger slide within the groove to move the first end of the single-edge blade towards and partially through the slit and continuing to slide the finger slide within the groove until the single-edge blade cuts a wrapper on a blade within the blade breaking pad and will hold the whole blade in place for breaking.

19. A method according to claim 18, further comprising a protective cover on the inside surface of the first panel that covers the groove and single-edge blade.

20. A method according to claim 19, further comprising one or more stops within the track furrow to prevent the blade or half-blades from moving to the at least one side edge.

21. A method according to claim 17, further comprising a slide mechanism comprising:
a channel through the first panel;
a slide button having an exterior end and an interior end and operably connected to the channel, wherein the exterior end is accessible from the outside surface and the interior end is positioned within the track furrow,
the method further comprising moving the slide button by the exterior end through the channel so that a blade or half-blade within the track furrow is moved to a side edge of the sheet.

22. A method according to claim 21, wherein the slide button moves a blade or half-blade to the side edge sufficiently that a blunt end can extend past the side edge.

23. A method according to claim 22, wherein at least the blunt end of the half-blade can be inserted into a storage container.

24. A method according to claim 22, further comprising one or more tabs overlapping the track furrow, wherein the tabs help guide the blade or half-blade towards the side edge.

25. A method according to claim 24, further comprising placing a blade at least partially under the tabs, so that the blade is between the track furrow and the tabs.

26. A method according to claim 25, further comprising one or more gripping pads fixedly attached to the outside surface of a sheet.

27. A blade breaking pad according to claim 26, wherein at least the inside surfaces of the sheet is magnetized.

28. A blade breaking pad according to claim 26, wherein at least the track furrow is magnetized.

29. A blade breaking pad, for cracking a razor blade into half-blades, comprising:
a sheet having an inside surface, an outside surface, at least one side edge, where the sheet is divided by a blade furrow having a top edge, a floor, and two upright sides, where the sheet is folded over the furrow into a first panel and a second panel fixedly attached to the top edge, such that the inside surfaces of the panels can be brought together over the furrow;
a first track fixedly attached to the first panel and a second track fixedly attached to the second panel wherein the first and second tracks are parallel to the blade furrow, such that one or more sharp edges of the razor blade can operably contact at least one of the first track and the second track and the blade before cracking is above the furrow, and where after the blade is cracked, the resulting half-blades are deposited into the furrow.

30. A blade breaking pad according to claim 29, further comprising a magnetic strip against the floor of the blade furrow to which the half-blades can attach and be removed from the furrow.

31. A blade breaking pad according to claim 30, wherein the magnetic strip comprises a long strand having multiple separation points that allow individual sections to be separated.

32. A blade breaking pad according to claim 31, further comprising spacers between the individual sections.

33. A blade breaking pad according to claim 30, wherein the magnetic strip comprises a magnetic roll in the form of a loop that slides within the blade furrow and around an exterior surface of the floor.

34. A blade breaking pad according to claim 33, further comprising one or more guides on the exterior surface of the floor for aligning the magnetic roll with the blade furrow.

35. A blade breaking pad according to claim 30, further comprising one or more gripping pads fixedly attached to the outside surface of a sheet.

36. A method for cracking a blade into half-blades, utilizing a blade breaking pad comprising:
a sheet having an inside surface, an outside surface, at least one side edge, where the sheet is divided by a blade furrow having a top edge, a floor, and two upright sides, where the sheet is folded over the furrow into a first panel and a second panel fixedly attached to the top edge, such that the inside surfaces of the panels can be brought together over the furrow;
at first track fixedly attached to the first panel and a second track fixedly attached to the second panel wherein the first and second tracks are parallel to the blade furrow, such that one or more sharp edges of the razor blade can operably contact at least one of the first track and the second track and the blade before cracking is above the furrow,
the method further comprising;
placing a blade over the blade furrow so that one or more sharp edges of the blade are parallel to the first track and the second track;
folding the first panel and second panel so that the inside surfaces are brought closer together; and
squeezing the first panel and second panel together so that their inside surfaces are against one another, causing the blade to crack into half-blades;
allowing the half-blades to be deposited into the blade furrow.

37. A method according to claim 36, further comprising a magnetic strip against the floor of the blade furrow to which the half-blades can attach and be removed from the furrow.

38. A method according to claim 37, wherein the magnetic strip comprises a long strand having multiple separation points that allow individual sections to be separated.

39. A method according to claim 38, further comprising spacers between the individual sections.

40. A method according to claim 38, further comprising separating an individual section to which half-blades have attached and removing the individual section and half-blades from the blade furrow.

41. A method according to claim 37, wherein the magnetic strip comprises a magnetic roll in the form of a loop that slides within the blade furrow and around an exterior surface of the floor.

42. A method according to claim 37, further comprising one or more guides on the exterior surface of the floor for aligning the magnetic roll with the blade furrow.

43. A method according to claim 42, further comprising moving the magnetic roll within the blade furrow until one or both of the half-blades attached thereto extend past a side edge of the sheet.

44. A method according to claim 37, further comprising one or more gripping pads fixedly attached to the outside surface of a sheet.
